(19) United States
(12) Patent Application Publication
(10) Pub. No.: US 2026/0261592 A1
(43) Pub. Date: Sep. 3, 2026

(54) Multimedia Conferencing Platform, And System And Method For Presenting Media Artifacts

(71) Applicant: FabZing Pty Ltd., Main Beach (AU)

(72) Inventors: Jon Frank Shaffer, Main Beach (AU); Gary John Smith, Main Beach (AU)

(73) Assignee: FabZing Pty Ltd., Main Beach (AU)

(21) Appl. No.: 19/659,818

(22) Filed: Apr. 27, 2026

Related U.S. Application Data
(62) Division of application No. 18/765,258, filed on Jul. 6, 2024.
Application No. 18/765,258 is a continuation-in-part of application No. 18/308,387, filed on Apr. 27, 2023, now Pat. No. 12,063,262.
Application No. 18/308,387 is a continuation of application No. 17/240,918, filed on Apr. 26, 2021, now Pat. No. 11,671,474.
(60) Provisional application No. 63/015,990, filed on Apr. 27, 2020.

(51) Int. Cl. H04L 65/75; G06F 21/32; G06F 21/64; G06N 3/08; G06N 20/00; G09B 5/06; H04L 65/1073; H04L 65/401; H04L 65/403

(52) U.S. Cl. CPC H04L 65/75; G06F 21/32; G06F 21/64; G06N 3/08; G06N 20/00; G09B 5/067; H04L 65/1073; H04L 65/4015; H04L 65/403

(57) ABSTRACT

A system and a method for processing multimodal inputs from users. The method includes interacting, by a processor, with a user on a first multimodal interface using an artificial intelligence (AI) engine. The interaction includes receiving inputs from the user through the first multimodal interface, and transmitting instructions generated by the AI engine based on the inputs. The method includes determining one or more assessment values based on the inputs and the instructions, and displaying the one or more assessment values on a second multimodal interface.

### CROSS-REFERENCE TO RELATED PATENT APPLICATION

The present patent application is a Divisional of U.S. patent application Ser. No. 18/765,258 filed on Jul. 6, 2024, which is a Continuation-in-Part application claiming priority from U.S. patent application Ser. No. 18/308,387, filed Apr. 27, 2023, and entitled “Multimedia Conferencing Platform and Method”, which in turn claims priority to U.S. patent application Ser. No. 17/240,918, filed on Apr. 26, 2021, which in turn claims priority to U.S. Patent Application No. 63/015,990, filed on Apr. 27, 2020, all of the disclosures of which are incorporated herein in their entirety by reference thereto.

### TECHNICAL FIELD

The present disclosure relates to a multimedia conferencing platform that allows for integration of various media, Uniform Resource Locators (URLs), and documents in real-time at higher resolution between two or more remote participants. The present disclosure also relates to media presentation formats. Particularly, the present disclosure relates to a multimodal media interface. Further, the present disclosure also relates to a system and method for display of and interaction between multiple media files, for example. The present disclosure also relates to generation of web-based applications or software applications.

### BACKGROUND

There has been a huge migration to video conferencing platforms for remote learning. However, these platforms such as Zoom (10 million users in December 2019 to over 300 million users in April 2020) do not typically have the ability to include interactive documents for testing. Messaging companies such as Messenger, WeChat, and WhatsApp allow sharing of media, but in a separated format whereby recipients of video and imagery view such media in a delayed format of their own time and choosing. They lack voice, video, and imagery except in the sense of a short time lapse between sending and delayed viewing by the recipient. This delay in viewing and or reading can range in length from a few seconds to minutes or longer depending on a number of variables that the sender is not aware of or cannot see. Video conferencing is a different form of communication with inherent shortcomings. The vicarious joy of seeing and hearing a recipient laugh or smile is lost or dramatically diminished when they receive a ‘LOL’ text instead of seeing the person laugh. The present disclosure describes a system and method replicating the interactivity and benefits in real time of in-person communication in referencing other media such as video and documents, even though participants are based remotely.

While messaging has more immediacy than email, it still does not meet a threshold of making participants feel as though they are in the same room together. Research reveals that working at home is more efficient and cost effective.

Screen sharing within video conferencing software offers poor resolution of whatever is being shared. Any other types of media sharing are cumbersome to attach (opening in a different window outside of the teleconference) and lack a mutual visual confirmation in real time. They then also lack interactivity.

Further, the nature of electronic document review and flow has traditionally been a static and linear examination of each element page by page (such as in case of Portable Document Formats (PDFs)), frame by frame (such as in video files), or line by line (such as in data structures). These information formats do not have a real-time multimodal capability with regard to other related contextual events or data flow. Multimodal presentation of information may be desirable in many applications. For example, usually there are multiple documents or files that need to be viewed concurrently, and understood/analyzed as part of a thoughtful decision-making labyrinth that is frequently exposed to the ‘distraction business model,’ which is especially prevalent in the online world. Multimodal presentation of media is also useful when two or more files have to compared with each other, or viewed concurrently. While the interfaces and level of interaction for each type of document vary to some degree, current solutions only allow one document or one media file (such as an image, a software, a video file, interactive interfaces, etc.) to be viewed at a time. Such linear approach diminishes context while adding exposure to distraction as it is impossible to open two or more media files at the same time.

Further, some applications may require interactions between the each of the documents/media files. In some applications, the media files may have to be updated based on the inputs provided, or user interactions with other media files. For example, in gaming applications, interactions in a first media file may influence information/content displayed on a second media file.

In another application, search engines may have interfaces that present information/media fields in a substantially linear manner. Search engines typically return a list of hits/results that are relevant to a query. However, existing search engines only allow results of one type of media to be returned (as selected by a user) and displayed at a time, i.e. either textual artifacts (such as PDF documents, Hypertext Markup Language (HTML)), images, or video. Existing interfaces only allow each of the results to be viewed one at a time, which removes significant contextual information. Since each of the results has to be viewed one at a time, it imposes greater strain on the user's working memory while researching. For instance, if the user wishes to compare two documents, either the user has to view and commit the first document to memory and then view the second document for comparison, or continuously switch between the two documents, thereby adversely affecting the user's experience. Users experience significant (mental) switching costs each time they switch to a new media file, and are likely to forget the context of the tasks (such as due to the ‘doorway effect’ characterized by short-term memory loss when passing through a doorway or moving from one location/website/interface to another).

Hence, there is a need for a method and a system for an interface for display of and interaction between multimodal media files/formats.

### SUMMARY

The present disclosure, in at least one preferred aspect, provides for a multimedia platform capable of presenting multiple media types concurrently. The platform may be configured depending upon the intended use. For example, in a legal setting, the platform can be configured to provide a one-way video, document, and video conference call simultaneously so that all participants receive the same presentation. In an academic setting, the platform may be configured to provide a one-way video, document(s) and video conferencing, but further include security enhancements tailored to the media type being presented (e.g., DocuSign verification for documents, or facial recognition to verify participant identity during an academic testing situation).

The present disclosure provides a method for displaying one or more media artifacts. The method includes receiving, by a processor, one or more inputs from one or more users through one or more tiles configured to display a corresponding media artifact, where the one or more tiles are configured to communicate with at least one of: other tiles, or an external entity. The method further includes receiving, by the processor, one or more retrieved data from either the other tiles or the external entity, where the other tiles or the external entities are configured to retrieve and transmit the one or more retrieved data in response to the one or more inputs. The method includes updating, by the processor, the media artifact displayed on the one or more tiles based on the one or more inputs.

The present disclosure also relates to a method for autonomously guided presentation of media artifacts. The method includes receiving, by a processor, an input from one or more users and generating one or more media artifacts in response to the input. The method also includes displaying, by the processor, the one or more media artifacts on one or more tiles. In some embodiments, the implementations of the methods may be facilitated by the use of an artificial intelligence (AI) engine.

It is to be understood that both the foregoing general description and the following detailed description are exemplary and explanatory only and are not restrictive of the present disclosure, as claimed. In the present specification and claims, the word “comprising” and its derivatives including “comprises” and “comprise” include each of the stated integers but does not exclude the inclusion of one or more further integers.

It will be appreciated that reference herein to “preferred” or “preferably” is intended as exemplary only. The claims as filed and attached with this specification are hereby incorporated by reference into the text of the present description.

The accompanying drawings, which are incorporated in and constitute a part of this specification, illustrate several embodiments of the present disclosure and together with the description, serve to explain the principles of the present disclosure.

### BRIEF DESCRIPTION OF THE DRAWINGS

FIG. 1A is an architecture diagram of a system, in accordance with embodiments of the present disclosure.

FIG. 1B is a screenshot of a video conference template with four tiles, each with a different media type, in accordance with embodiments of the present disclosure.

FIG. 1C is a screen view of a smartphone with an exemplary multimedia conferencing home page, in accordance with embodiments of the present disclosure.

FIG. 1D is a screen view of a smartphone with an exemplary tiled multimedia streaming to the smartphone, in accordance with embodiments of the present disclosure.

FIG. 1E is a screen view of a smartphone with an exemplary tri-tiled multimedia streaming to the smartphone, in accordance with embodiments of the present disclosure.

FIG. 1F is a screen view of a smartphone with an exemplary tri-tiled multimedia streaming to the smartphone with a video on the top tile, a document presentation a middle tile, and a multi-person video conference call on the bottom tile, in accordance with embodiments of the present disclosure.

FIG. 2A illustrates a block diagram of a network architecture having a system for an interface/multimodal format for display of and interaction between multimodal media, in accordance with embodiments of the present disclosure.

FIG. 2B illustrates a block diagram of the system, in accordance with embodiments of the present disclosure.

FIGS. 3A-3I illustrates screen views of the interface being used for various applications, in accordance with the embodiments of the present disclosure.

FIG. 4 illustrates a flowchart of an example method for enabling interaction between tiles, and with external entities, in accordance with embodiments of the present disclosure.

FIGS. 5A to 5C illustrate screen views of the interface being used for creating/generating web-based applications or software applications, such as websites, in accordance with embodiments of the present disclosure.

FIG. 6 illustrates a flowchart of example method for generating applications using the multimodal interface, in accordance with embodiments of the present disclosure.

FIG. 7 illustrates a flowchart of example method for autonomously guided presentation of media artifacts based on user inputs, in accordance with embodiments of the present disclosure.

FIGS. 8A and 8B illustrate screen views of the system autonomously guiding presentation of multiple media artifacts based on user inputs, in accordance with embodiments of the present disclosure

FIG. 9 illustrates an example computer system in which the system is implemented, in accordance with embodiments of the present disclosure.

### DETAILED DESCRIPTION

Reference will now be made in detail to the present preferred embodiments of the present disclosure, examples of which are illustrated in the accompanying drawings.

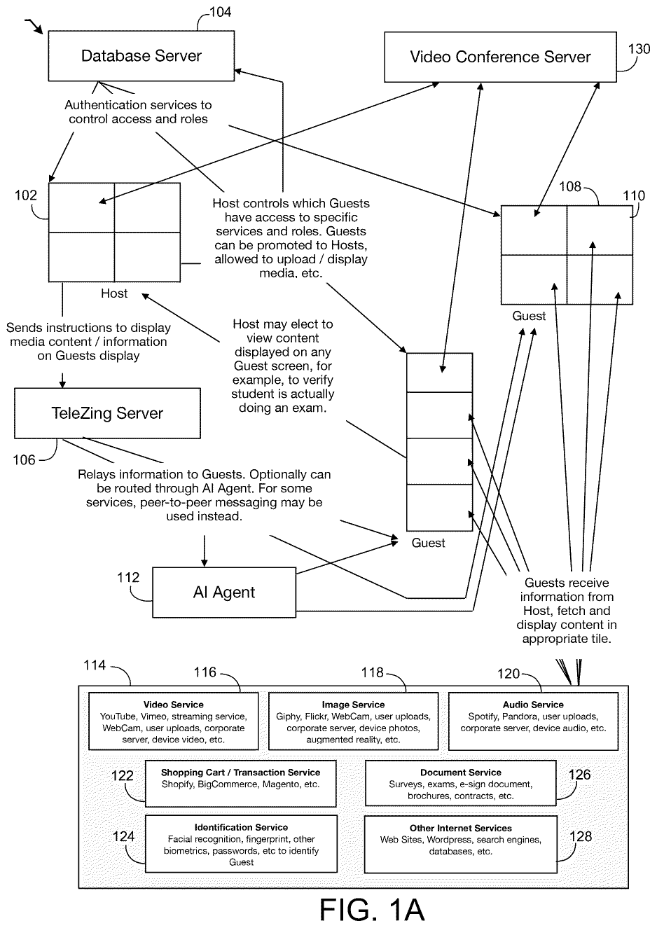

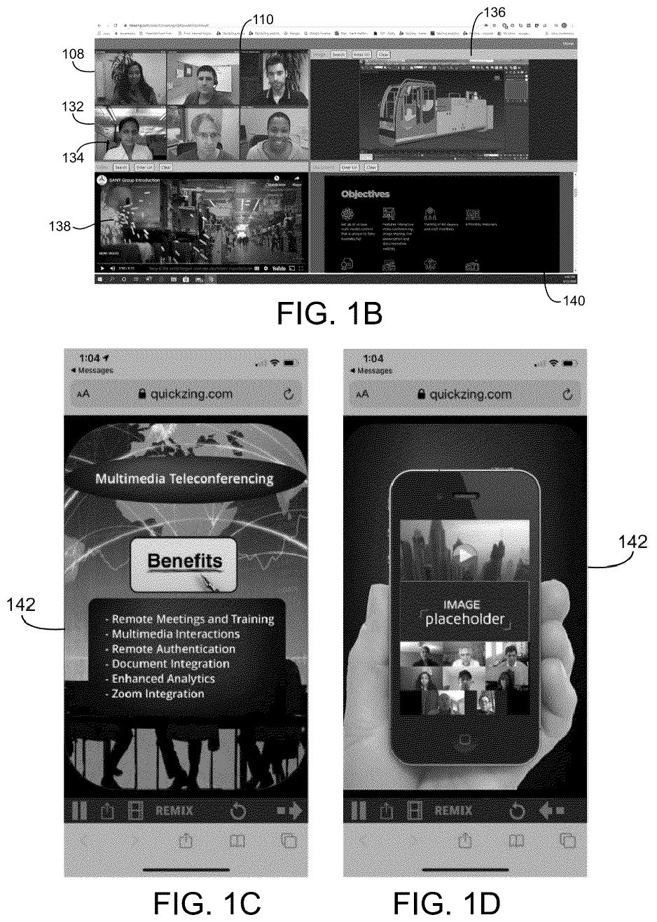

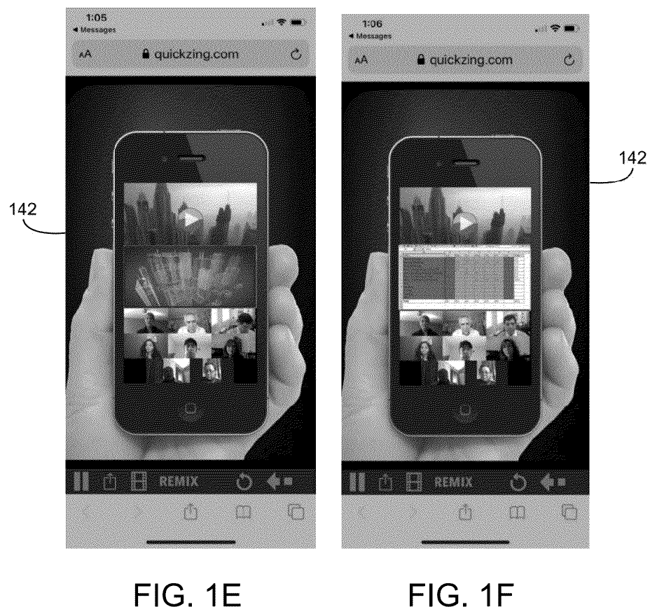

FIGS. 1A and 1B show a preferred embodiment of a system or platform 100 having a processor 102, a database server 104 that stores data pertaining to registered users, and a compiler 106 that builds a template 108 with a plurality of tiles 110, each tile matching a media type artifact allowing a user monitor to display multiple forms of media artifacts concurrently. The system 100 preferably includes an artificial intelligence (AI) agent 112 to analyze a participant/user's habits and portray the media artifacts in a manner for conducive to the viewing style of the user, among performing other functions. The preferred elements of platform 100 and their interrelationship are described below.

Referring to FIG. 1A, processor 102 preferably functions as a “host” in the overall system. The processor 102, among performing other functions described subsequently in the present disclosure, controls which users/participants/guests have access to specific services and roles. Participants can be promoted to have host access to upload or display media artifacts depending on the situation. The processor 102 is configured to send instructions to a user/client station to display media content and information according to its original media format of creation.

The database server 104 is a user database containing contact details of users permitted access to platform 100. The database server 104 preferably includes authentication services to control access and maintain appropriate user roles. The compiler 106, shown as a “Telezing Server” in FIG. 1A, may be configured to present a multimedia template 108 at a user/client workstation.

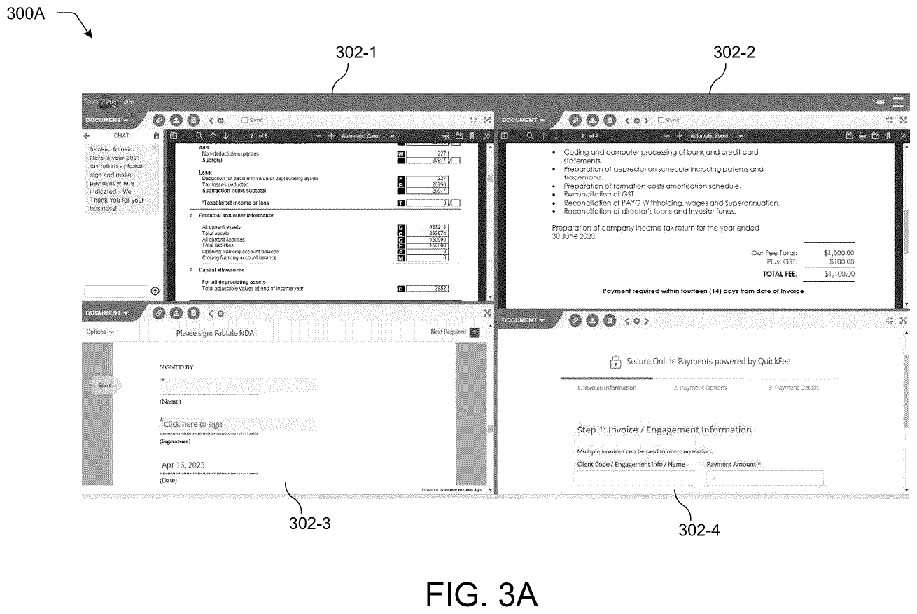

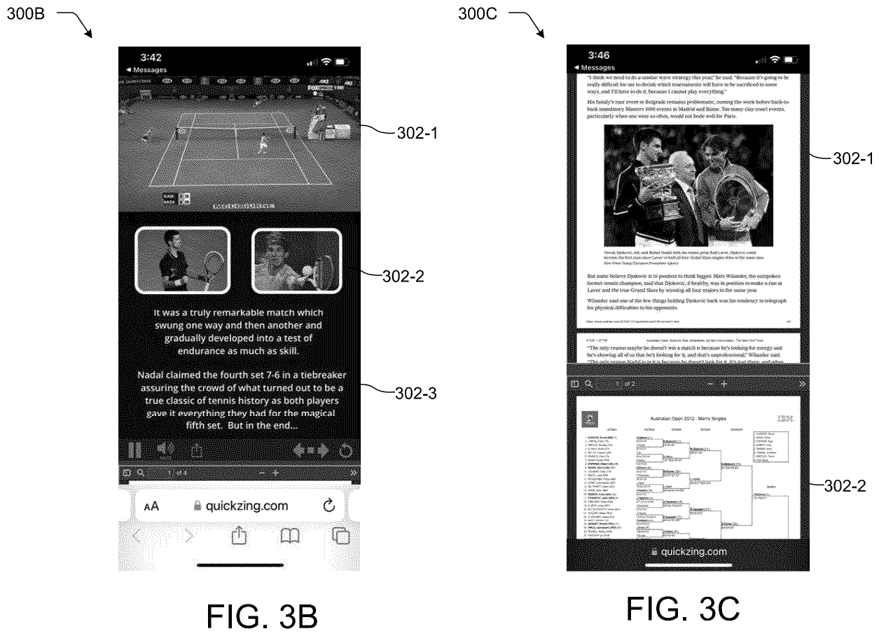

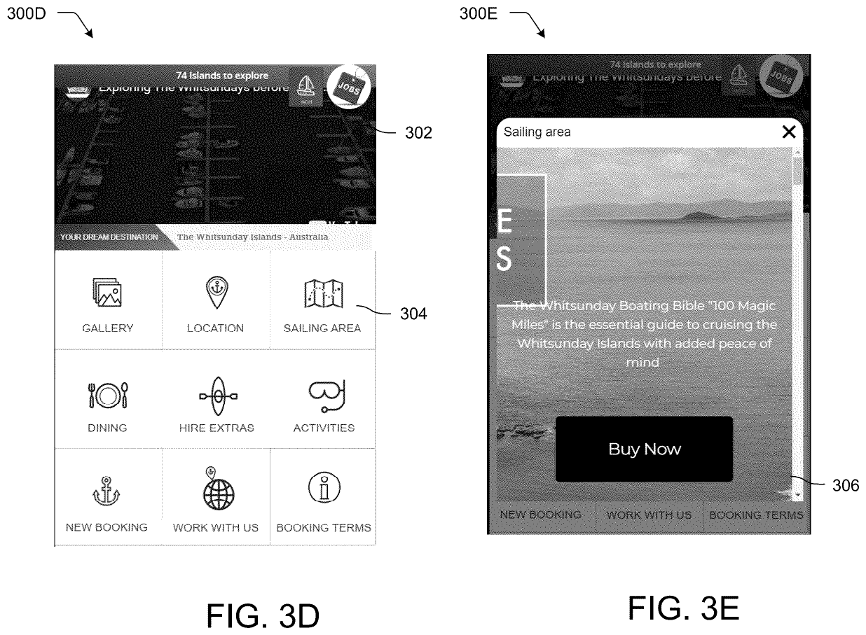

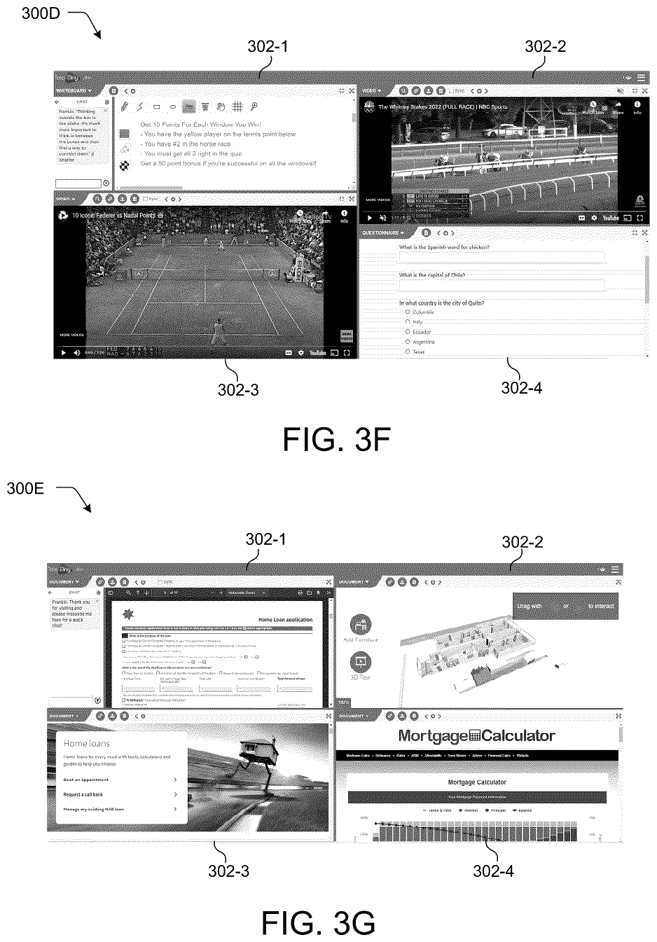

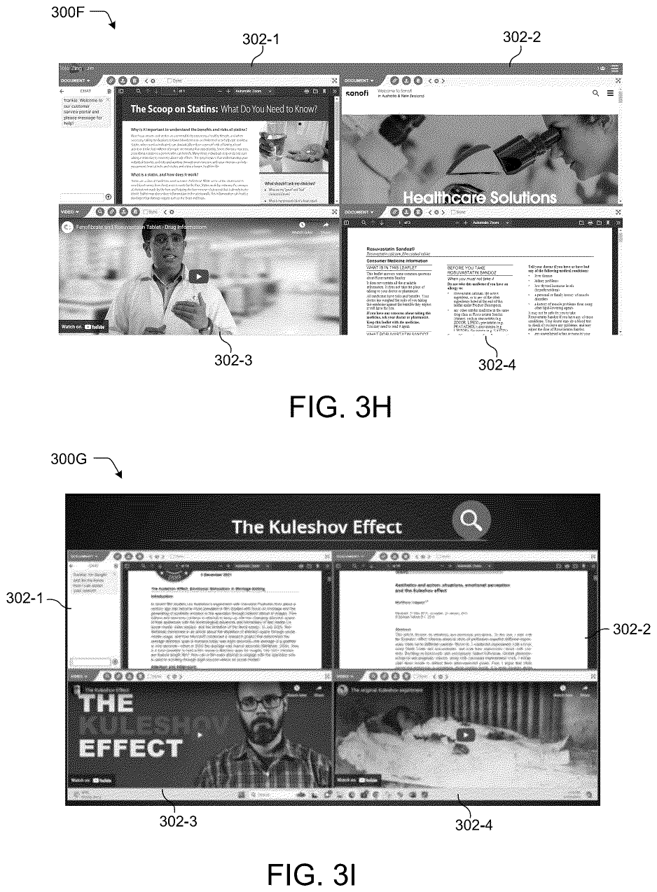

The template 108 includes a plurality of tiles 110, each tile 110 corresponding to a different media type. The compiler 110 is configured to identify a media type of an incoming media stream or media presentation, and route the incoming media to at least one of the tiles 110 having a matching media type so that the media stream or presentation displays in the tile 110 corresponding to its media type. The type of media artifact assigned to the tile 110 may be selected by the user of the system 100, or determined automatically by the system 100 based on the context. Throughout the specification, media artifacts mean and include images, video, audio, documents, or any other form of digital media, but not be limited thereto. The tiles 110 may allow the user to view multiple forms of media concurrently. For example, each tile 110 may display different types of media files, as shown in FIGS. 3A-3I. By presenting the media files concurrently, the system 100 enables the user to use and view various forms of information at the same time, thereby presenting information with enhanced context and improving user experience. The type of media assigned to the tiles 110 may also be adaptable/changeable during run-time based on requirements/context.

The template 108 may be configured to present tiles corresponding to at least two or more of the following media types and/or services 114, but not limited thereto, listed in FIG. 1A, which includes incoming one-way video or two-way video conferencing streaming video service 116, still media or image service 118 (e.g., Joint Photographic Experts Group (JPEG), DOC/DOCX, Portable Document Format (PDF), and the like), audio service 120 (preferably portrayed with a static visual image), a shopping cart transaction service function 122, an identification service 124, such as with a biometric technology like facial recognition, fingerprint scan, and so on; an interactive document service 126 (e.g., surveys, exams, e-sign documents, contracts, etc.), and a tile for other services 128 such as websites, WordPress, search engines, and access to other databases. In other embodiments, the media types/media artifacts may also include text documents, images, videos, audio, interactive interfaces such as websites or software applications, browsers, scanners, whiteboards, streaming content, video/audio conferencing, social media feeds, instant messaging, search windows, chatbots, Esignatures, screen sharing, location tracking, telephony, blockchain, quick response (QR) codes or other automatic identification and data collection (AIDC) means (such as barcodes, radio frequency identification, biometrics, magnetic strips, smart cards, optical character recognition, voice recognition, and the like), games, and the like. Each type of media artifact may be defined using a corresponding data structure. For example, images may be represented using an array of tuples, with each tuple having three scalar values. Further, video files may be represented using an array of images. Meanwhile, interactive interfaces may be implemented using a combination of programming logic, as supported by any one or combination of markup (such as Hypertext Markup Language (HTML)), scripting languages (such as JavaScript), styling scripts (such as cascaded styling sheets (CSS)), or the like.

Continuing with reference to FIG. 1A, the platform/system 100 may include AI engine 112 to analyze a participant/user's habits, and portray the media in a manner for conducive to the viewing style of the user. If desired, media from the compiler 106 may be routed through AI engine 112 before assembly at the template 108 to enhance the portrayal of the media at the client display. For some services, peer-to-peer messaging may be used instead. The AI engine 112 may be implemented within the system 100, or may be external to the system 100. The AI engine 112 may be configured to receive the media artifacts as input, and determine a combination of the media artifacts to be presented in the tiles 110 as output based on the context (such as inputs provided by the user, the context for which the AI engine 112 has been trained, usage patterns of the user, and the like, but not limited thereto). The AI engine 112 may be implemented using any one or combination of symbolic models (such as expert systems), machine learning models (such as neural networks), or statistical models (such as Bayesian Classifiers). In some embodiments, the AI engine 112 may be an AI agent configured to orchestrate operation of multiple AI models. For example, the AI agent may be configured to operate at least one classifier, at least one large language model or large multimodal model, at least one diffusion model, at least one autonomous agent, and the like, but not limited thereto. The AI engine 112 may be configured to use any combination of the models to perform/execute a predefined set of functions. In some embodiments, the AI engine 112 may include multiple instantiations of the same models or similar classes of models. In such embodiments, the AI engine 112 may use consensus/similar between outputs of multiple instantiations of the models to prevent hallucinations, and thereby improve accuracy.

The video conferencing services 116 may involve a more complex form of communication. Preferably, a designated video conferencing servicer 130 is specially configured to handle video data from a user camera to a display to another user's monitor, often across many participants concurrently.

FIG. 1B shows an exemplary display that is templated into four tiles 110. A video conferencing tile 132 is configured for display and functionality of interactive video conferencing. Conferencing tile 132 includes a plurality of participant windows 134 corresponding to the video feed originating from a participant camera at the participant/client end. A still image tile 136 is configured to display still images concurrently with functionality of the video conference call. An incoming, one-way video tile 138 is configured to display a video separately from the video conference call. A fourth tile, a document tile 140, is configured to display documents such a portion from a Word document, a PDF, or a power point display. As shown in FIG. 1B, the enumerated formats above are compiled at the user/participant display, and portrayed concurrently. Video conference participants view the same media tiles 110 being seen by each participant, except where one or more forms of media portrayal have been individually slightly altered through interaction with AI engine 112 (described further below).

The arrangement of tiles/windows/placeholders may fluidly change based on the device and aspect in which it is held or viewed. In some embodiments, smartphones may stack the tiles 110 vertically and when the smartphone is held horizontally the top media tile may expand to full screen with the other tiles 110 easily accessed by scrolling down. For example, mobile phones may stack windows vertically and when the phone is held horizontally the top media window shall format to full screen with the other windows easily accessed by scrolling down. The tiles 110 or windows can easily be rearranged in the order or layout the viewer wishes (click and drag). Each window may have its own scroll down, zoom, or slide component depending upon the nature of the content it is displaying. On laptops and computers, the default format will preferably have four windows arranged initially in a quadrant layout, such as shown in FIG. 1B.

The size and positions of the tiles 110 may be changed based on the user's requirements/inputs. In some embodiments, the tiles 110 may be arranged based on the template 108. The template 108 may specify the arrangement, positions, and/or the sizes of the tiles 110. The template 108 may be selected based on requirements. The tiles 110 may be rearranged in any order or layout the user/viewer wishes (click and drag, or by changing orientation of the device). Each tile 110 may have its own scroll down, zoom, or slide component depending upon the nature of the content it is displaying. On other devices such as laptops and computers (or generally where the size of the display of the user's device is greater than 8 inches), the tiles 110 may be arranged in 2×2 grid quadrant layout. However, it may be appreciated by those skilled in the art that the layout/arrangement, size, position, and type of media displayed on the tiles 110 may be suitably adapted based on the device (and configurations and specifications thereof) in which the system 100 is implemented. In some embodiments, the tiles 110 may also be arranged such that a first tile overlaps over a second tile.

It will be appreciated that presentation on a computer monitor is not essential. Multimedia presentation on hand-held devices, such as tablets and smartphones, is also possible. FIGS. 1C-1F show video conferencing in combination with a still media and one-way video presentation on a smartphone 142.

The compiler 110 may be configured to act as a multi-level security gateway that is configured for multiple media types. As a security gateway, the compiler 110 may be configured to accommodate one or more of a document verification security protocol, a document signature (e-signature) verification security protocol, and biometric verification security protocol, which may include the use of facial recognition technology. Other security protocols are possible, as would be appreciated by one of ordinary skill in the art.

The applicability of the platform 100 is adaptable and beneficial across a wide range of uses. For example, the platform 100 may be specifically tailored to an academic online learning environment. The template 108 may include a first tile for live video conferencing with multiple participants (e.g., students), a second tile for a document presentation, such as a Word, PDF or other still image, and a third tile for a power point presentation. The compiler 106 may utilize a multi-level security gateway function for student identification verification, document submission, and student testing soundness (verifying that student exam responses are delivered to the learning institution without input by third parties other than the student providing the answers).

In an academic setting, the platform 100 may be configured for one-to-one screen sharing between teachers and each individual student for the purposes of test taking and monitoring. A teacher's dashboard may allow the teachers to view and monitor each student's computer screen during the test as they saw fit along with artificial intelligence in the background (described below) that could pick up unusual activity, red flags, learning patterns, shortcomings, glitches, and the like. This would be complemented by the video component in video conferencing, for example, as another visual monitoring system in conjunction with the student's screen.

The platform 100 may include a teaching bot teacher and tutors spearheading a multimodal learning platform that is interactive in real time. These teaching counselors/bots would effectively be on call 24/7 and tap into the multimodal strengths and weaknesses of each student across a personalized learning platform. The infusion of AI with multimodal (voice, imagery, video) delivery would create a compelling personality to drive engagement beyond typical levels. The scalability of bot tutors mixed with pre-existing famous personality characteristics that are personalized on a “one-to-one” basis would solve the Bloom 2 Sigma Problem resulting in a factor even greater than two for educational outcomes, as described subsequently in the present disclosure.

In another context, the platform 100 may be specifically tailored to the legal environment where the template 108 includes a first tile for live video conferencing with multiple participants (e.g., opposing lawyers, a judge, and one or more witnesses, and even groups of individuals such as a jury), a second tile for a document presentation (simulating a whiteboard format, or displaying still images such as photographs of a scene), and a third tile for an incoming one-way video stream, such as a setting of a courtroom, or video of a crime scene, etc.

An academic or legal context is but two examples of the wide applicability of platform 100 for different situations in today's world. It will be appreciated that a template may be configured for other contexts as well.

Where platform 100 includes an AI agent, such as AI engine 112 shown in FIG. 1A, the use of the AI engine 112 depends on the context that platform 100 is being used. For example, in an online academic context, AI engine 112 may be configured to compare the demographics of the user student with the user's prior interactions with learning material in the academic setting, and determine if the user is a visual, auditory, and/or abstract leaner; or a kinesthetic learner based on the output of the classifier. The primary classifier in the above-described example is preferably an artificial neural network.

In other settings, and in general, a video conferencing business setting, the AI engine 112 may be configured to compare the demographics of a user at their workstation, the geographical location of the workstation, and the subject matter of the incoming communications to determine a portrayal of an incoming media to the user based on the output of the classifier. In this situation, a neural network is also a preferred primary classifier.

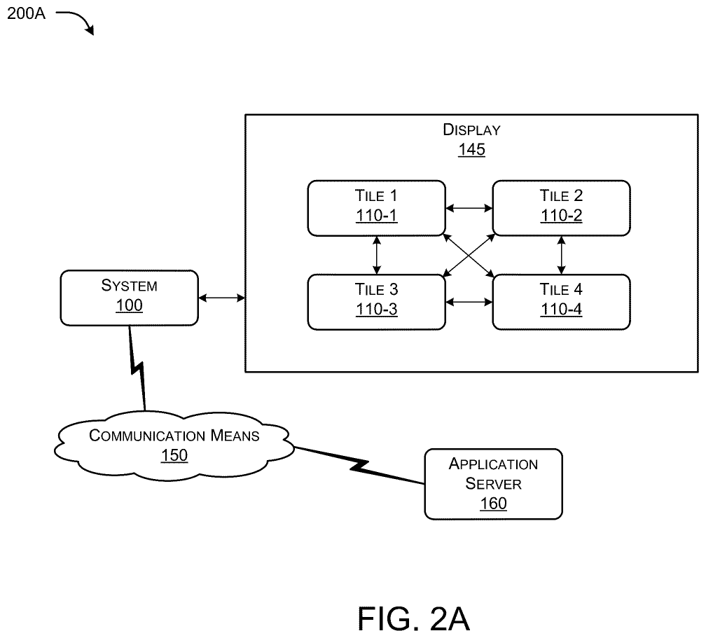

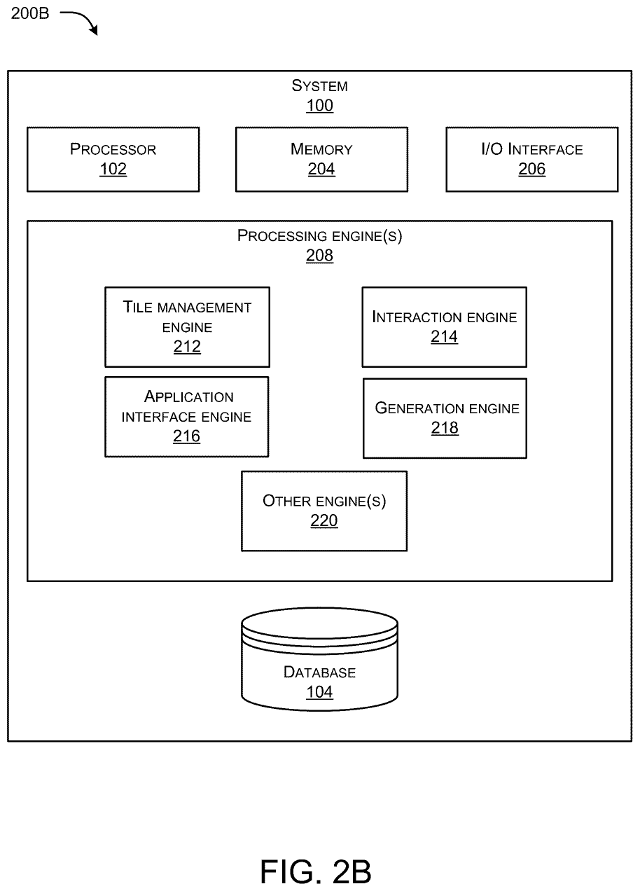

Having described the preferred components of the platform 100, a preferred method of use will now be described for displaying multiple live media streams from a single communication. First, incoming media streams are split according to media type. Next, the media type of an incoming stream of media artifacts may matched with a media type of a predesignated tile of a screen template being displayed on a user's monitor. Then the matched media artifact may be displayed in the correct tile on the user's monitor or any display device (such as display 145 shown in FIG. 2A). At least a first of the incoming stream of media artifacts may relate to an interactive video conference call. At least a second of the incoming stream of media artifacts may relate to a presentation of documents. At least a third of the incoming stream of media artifacts may relate to a presentation, such as a power point presentation. It will be appreciated that other media types are applicable, and may be added or substituted as appropriate. For example, a fourth media stream of media artifacts may relate to a one-way video of an indoor setting may be split and matched in a similar fashion as outlined above.

Where desired, a method implemented by the system 100 may include the use of AI engine 112 to compare the demographics of the user with the user's prior interactions with learning material in an indoor setting, such as a classroom, webinar, or corporate training session, and determine if the user is a visual, auditory, and/or abstract leaner; or a kinesthetic learner based on the output of the classifier. Alternatively, the method may include using AI engine 112 to compare the demographics of the user with the user's prior interactions with incoming streaming material, and determine at least one of content suggestions, content improvements, content enhancements, and content edits based on the output of the classifier.

It will be appreciated that the steps described above may be performed in a different order, varied, or some steps omitted entirely without departing from the scope of the present disclosure.

The foregoing description is by way of example only, and may be varied considerably without departing from the scope of the present disclosure. For example, a multitude of tiles or windows may be included to specifically accommodate other formats, such as augmented reality, “Quickzing” (the inventor's own format described PCT Publication No. WO 2015/151037, the entire disclosure of which is hereby incorporated by reference herein), and any other type of media with a livestream/or site which can be viewed via Uniform Resource Locator (URL), and the like. Additional formats may include Learning Management Systems (LMS), gaming, Twitter or X/news feeds and/or sports (e.g., a live football game could be streamed in one window while a variety of people in a video conference call view it together along with another gaming window which articulates gaming details of their fantasy football league). The platform 100 may also be configured for use in the medial field as desired.

The platform 100 in a preferred form provides the advantages of reduced travel costs, multi-modal learning, remote verification of training modules and certification testing. Media content, such as images, video, and documents and PDF files, etc., are of much higher quality and resolution in the above-described system compared to a conventional video conference call environment that rely on a screen share feature with lower resolution.

The platform 100 in a preferred form also allows for heightened interactivity of each type of media or document (e.g., a teacher handing out/initiating a test or a pop quiz along with corresponding analytics, authentication, and monitoring). This interactivity across media, documents, shopping carts, eSignatures, etc., with multimodal (visual, audio, biometric) confirmations in real time will naturally accelerate the effectiveness, efficiency, and richness of communication across virtually every business vertical, learning applications, and social interaction. From a security standpoint, combining a multiplicity of communication and content windows with other windows comprised of phone calls or messaging services creates multiple layers of content firewalls versus one used in isolation.

Using QR codes (and the like) can also act as an excellent gateway to a multiplicity of interactions through this multimedia platform. Traditionally, the OR codes link to a singular URL which forces a one size fits all approach to interactions which reduces engagement and conversions. Also, the current approach to communication across media typically involves a fragmented series of linear interactions and pages that require a number of decisions in sequence to complete a transaction. Spreading out numerous decisions across several pages/interactions further diminishes outcomes and conversions. However, creating a wider multimodal approach concurrently in one place, lends itself to ‘simultaneous decision making. An example embodiment may involve a QR code on a real estate sign whereby upon scanning the code a prospect is presented with 3-4 tiles stacked vertically on their phone. One window could be a call or messaging tile with further windows covering a wide range of interactions and content such as: 3D imagery of the house, documentation, company/house videos, esignatures, surveys, all the way to blockchain and identifier authentication biometrics for financing/purchasing. Every element of a transaction from initial awareness/marketing touch point to closing on the sale of a house can be completed in one platform in the palm of your hand.

Another embodiment may involve gathering information as part of a multimodal research platform. A number of large ‘survey’ companies dominate the Research and Development (R&D) market with millions of other ones filling out the landscape. Remote R&D and focus groups could be implemented through the platform via a variety of windows in conjunction with each other such as—A remote moderator/or textual instructions, a video commercial being tested, a survey to be completed after viewing the video etc.

A further embodiment would involve virtually every touch point across the recruitment and employee journey. A sample layout for gathering the initial job application in the multimedia format could involve the following four windows—A. upload your resume and cover letter. B. Record a video of yourself answering questions viewed in another window. C. Information about the company. D. A questionnaire, sample work document or e-signature. Subsequent touchpoints, such as an interview, may take on another mix of windows that would include a video conferencing tile along with other options such as testing, or interactive whiteboards and biometrics. Further interactions with employees could also take on a multimodal format, for example, when conducting reviews of personnel. All possible interactions across the various types of multimedia during an employee's journey may create a rich archive of data, allowing the entire spectrum from initial application and interview, through to retirement to be analyzed.

Another embodiment may be to retrofit medical equipment via a QR code and or ‘Multimedia Telemedicine’. A sample use case in this scenario could involve an imagery window for x-rays and the like along with a video conferencing window between the doctor/nurse and patient, along with an electronic healthcare record (EHR) window, along with a tutorial or explanatory video, prescription document, e-signature, and any number of other complimentary tiles that expedite, verify, and simplify interactions between patients and healthcare staff. A remote patient could be instructed to walk in front of their webcam so that the doctor could implement video AI for use in determining if they needed a hip replacement surgery, or to diagnose Parkinson's disease by their gait. Such guidance would work much more effectively with both parties accessing concurrent windows in their communication.

A further embodiment could involve e-commerce. While video has effectively taken over the internet and become an important tool in marketing, there is no simple unified way to quickly close a transaction after a video marketing campaign puts out a call to action. With this platform however, any video commercials or calls to action can have an adjoining tutorial video, company information, 3D product imagery, shipping details, biometric authentication, and payment windows all together concurrently so that consumers have every element necessary to complete a transaction. This would increase revenue and reduce shopping cart abandonment rates (currently around 76%) by creating simultaneous decision making and removing distractions from the customer journey. Television, streaming video and online campaigns could also include QR codes on their broadcasts linking to this concurrent layout of a variety of URLs and interactions.

The system 100 may also be configured to allow interaction between multimodal media in a unified platform/interface. The system 100 may use multimodal media interfaces/formats for dynamic presentation of media files/information, and generation of web-based applications/artifacts. The system 100 may use a multimodal format/interface for creating, storing, mixing, editing, and sharing information in multiple media types/forms. The multimodal interface (such as those including the tiles 110) may be an online file format used for information interchange among diverse products and applications on multiple platforms, as described in references to FIGS. 2A to 9. The multimodal interface allows for a much wider range of communication and learning styles than unimodal approaches or one format in isolation which often times lacks proper context. By providing media of different types to be viewed concurrently, the multimodal interface may allow users/viewers to concurrently compare or verify the contents of multiple media files (of same or different types) presented through the format.

For example, a spreadsheet in isolation is very poor at evoking or creating emotional understanding. A video on the other hand is often quite good at conveying emotion although it is not a suitable format to submit a tax return. In another example, when an individual writes on their resume or a job application that they are fluent in Japanese, in isolation from any other media source is not a sufficiently demonstrable data point. The multimodal interface may allow a viewer to see and hear the individual speaking Japanese fluently to properly measure the job applicant's abilities. This complimentary multimodal approach to information flow and communication would be more accurate, efficient, and useful over a prolonged time frame than unimodal representations in isolation. Humans are multimodal animals as is the world around them, and consequently need a broader mixture of modalities to communicate and learn more efficiently. Additionally, many applications may require interaction between the multiple media files/artifacts displayed on the multimodal interface. For example, applications in gaming may require inputs or changes in a first media file (such as a live feed of a tennis match) to change values or artifacts in a second media file (such as score or betting information) presented through the multimodal interface. Furthermore, the multimodal interface may require interaction with external applications for retrieving, curating, and/or updating the information/data/content being presented through the multimodal interface. The multimodal interface may also allow for creation of web-based applications, such as websites, since the needs of such application can be fulfilled by presenting multiple media artifacts on a single interface.

In some embodiments, the tiles 110 may be configured to communicate/interact with each other and/or with external entities. FIG. 2A illustrates an example network architecture 200A. The network architecture 200A includes an example implementation of the system 100 configured to provide multimodal media interface/format on a display 145, where the tiles 110 of the multimodal media interface are configured to interact with each other, as well as external entities. The display 145 may include one or more tiles, such as tiles 110-1 to 110-4, which may display at least one media file/artifact therein. The system 100 may be configured to communicate with one or more application servers 160 through a communication means 150, thereby allowing the tiles 110 to send and receive information to and from external entities. While FIG. 2A shows few components of the network architecture 200A, it may be appreciated by those skilled in the art that the network architecture 200A may be suitably adapted to include other components or elements not explicitly shown in FIG. 2A based on requirements.

The system 100 may use an interface (such as a graphical user interface (GUI)) or the multimodal interface on the display 145 to present the media artifacts. The system 100 and the display 145 may be implemented in a computing device, such as any one of including, but not limited to, smartphones, laptops, tablets, phablets, desktops, servers, and the like. In some embodiments, the display 145 may be implemented in a different device than the system 100. For example, the display 145 may be implemented in monitors, projectors, virtual reality/augmented reality headsets, and the like, that are connected to the computing device implementing the system 100. The display 145 may include one or more pixels each associated with a coordinate value, which may be used to position and place the tiles 110 thereover. In some embodiments, the system 100 may be implemented as a server that provides services to computing devices operated by the users. The server may be based on a virtual facility, such as the facility operated by the applicant as FabZing®. Details of the implementation of this system (at least in some embodiments) are provided in the Patent Application No. WO 20112041827 (US 61/272,545) and U.S. Provisional Application No. 61/746,774, which are hereby incorporated by reference. A suitable implementation of a server based, user-controlled multimedia messaging system is the FabZing® system, which is available at www. fabzing. com and is commercially operated by the present assignee. In other embodiments, the server may be implemented within the user's device, or in any other suitable computing device.

The multimodal interface includes the tiles 110, which are data structures indicative of containers or window containers that may be used for presenting/displaying media artifacts. Boundaries of the tiles 110 may be defined using coordinate values. The coordinate values may indicate the position and size of the tiles 110 on the display 145. Each of the tiles 110 may have the same or different type of media artifact displayed therein.

In some embodiments, the (window) containers may be configured to display media artifacts on a two-dimensional (2D) interface, such as in a GUI. In other embodiments, the containers may be adapted for application in three-dimensional (3D) interfaces, such as in a virtual reality (VR) or an augmented reality (AR) environment. In such embodiments, the containers may be configured to have a 3D representation, and may be configured to display 3D media artifacts.

In some embodiments, at least one of the tiles 110 may allow the user to provide inputs to the system 100. The inputs may be received through text boxes filled by the user, clicks using a cursor or a touchscreen, audio inputs, video inputs, or kinesthetic inputs using corresponding hardware devices, and the like. In some embodiments, the system 100 may allow users to upload the desired media files for presentation on the tiles 110. In other embodiments, the system 100 may store the media artifacts in the database 104.

In some embodiments, the tiles 110 may be configured to communicate with each other. Allowing the tiles 110 to communicate with each other may allow the tiles 110 to be updated based on the user's inputs. In some embodiments, a first tile may communicate by calling methods or functions associated with the second tile, or making application programming interface (API) calls to a resource locator or a path of the second tile. In other embodiments, a communication framework, such as a publisher-subscriber framework as known in the art, may be configured to allow communication. The communication framework may allow the first tile and the second tile to subscribe to each other's events, and trigger corresponding actions therefrom. It may be appreciated by those skilled in the art that the multimodal interface may be suitably adapted to allow communication between the tiles 110 using any other protocol and/or framework known to those skilled in the art. The system 100 may allow the tiles 110 to interact with each other to update the information/content therein. For example, a first tile may allow for video conferencing, such as between an agent and a customer in call center environment, and a second tile may display sentiment/emotion of the customer based on the conversation in the first tile. In such examples, the second tile may retrieve transcriptions of the audio input and output from the video conferencing interface in the first tile to determine the sentiment of the customer. Other examples are described in detail in reference to FIGS. 3A to 3I.

In some embodiments, the system 100 may be configured to communicate with one or more external entities, such as the application servers 160 through the communication means 150. The communication means 150 may be indicative of wired or wireless communication means. Examples of wired communication means may include, but not be limited to, electrical wires/cables, optical fiber cables, and the like. Examples of wireless communication means may include any wireless communication network capable of transferring data using means including, but not limited to, radio communication, satellite communication, a Bluetooth, a Zigbee, a Near Field Communication (NFC), a Wireless-Fidelity (Wi-Fi) network, a Light Fidelity (Li-Fi) network, a carrier network including a circuit-switched network, a packet switched network, a Public Switched Telephone Network (PSTN), a Content Delivery Network (CDN) network, an Internet, intranets, Local Area Networks (LANs), Wide Area Networks (WANs), mobile communication networks including a Second Generation (2G), a Third Generation (3G), a Fourth Generation (4G), a Fifth Generation (5G), a Sixth Generation (6G), a Long-Term Evolution (LTE) network, a New Radio (NR), a Narrow-Band (NB), an Internet of Things (IoT) network, a Global System for Mobile Communications (GSM) network and a Universal Mobile Telecommunications System (UMTS) network, combinations thereof, and the like.

The application server 160 may be configured to allow the tiles 110 to communicate and retrieve information/data associated with one or more artifacts from the external entities or the internet. The application server 160 may be configured to retrieve the data based on one or more inputs/queries received from the user. The application server 160 may retrieve and transmit the data to the system 100. For example, the application server 160 may be indicative of a search engine configured to retrieve results/hits/search retrieved data for a query/input provided by a user of the system 100. The query/inputs may be communicated/transmitted to the application server 160 through the communication means 150. The application server 160 may be configured to retrieve or generate data, which may be returned to system 100 through the communication means 150. The data may then be presented in any one or more of the tiles 110, or may be used to update the information/contents of the tiles 110.

For example, the system 100 may redirect the query received from a user through one of the tiles 110 to the application server 160. The application server 160 may perform a search for the query using techniques known to the art, such as by making API calls to known search engines, for example. In some embodiments, the application server 160 may make API calls to a plurality of search engines, where at least one of the search engines is associated with each media file/format. For example, a first search engine may return textual artifacts as results, a second search engine may return videos as results, a third search engine may return audio recordings (such as podcasts or sound effects) as results, a fourth search engine may return images as results, etc. The results of each of the search engines may be returned to the system 100. The system 100 may process the search results, and select a subset of results for presentation in the tiles 110.

In some embodiments, the system 100 may include the AI engine 112. In the foregoing example, the AI engine 112 may be configured to select the subset of results. The AI engine 112 may be trained to select a combination of media artifacts from the search results that maximize the context information/user experience. For example, the AI engine 112 may be configured to select a research paper describing an experiment, as well as a video describing enacting that experiment. In another example, the AI engine 112 may select textual descriptions of a muscle of a human body, and a 3D model of the muscle in adjacent tiles 110, thereby allowing the user to have a mental and visual explanation therefor. By providing multiple media artifacts associated with the same information/inputs provided by the users, the system 100 provides additional context to the user. Further, in such examples, the additional context reduces the chance of the user misunderstanding the information. For instance, in case the user misunderstands the textual description of the experiment or a muscle, the user can confirm their understanding using the corresponding visual description. Additionally, given not all search results include multimedia descriptions for a topic/information, the AI engine 112 may allow search results created by different authors to be combined and presented to the users as a multimedia description. Alternatively, the AI engine 112 may be trained to select the subset of results based on the requirements of the user or the application. The AI engine 112 may be configured to analyze a participant/user's habits and portray the media in a manner that is conducive to the viewing style of the user (for example, the AI engine 112 may determine the combination of media artifacts to be selected based on historical data associated with patterns of media types assigned to the tiles 110 selected by the user on previous uses of the multimodal interface).

In other examples, the application server 160 may relate to a server providing real-time stock market price data, or real-time data from a cryptocurrency exchange. In such examples, the system 100 may be configured to retrieve such data from the application server 160 in real-time, and use the AI engine 112 to make the predictions or recommendations. The real-time data and the analysis may be presented in separate tiles in the multimodal interface. The AI engine 112 may be configured to make decisions on whether to buy or sell based on the real-time data.

In some examples, the AI engine 112 may also include natural language processing capabilities. For example, the AI engine 112 may be implemented as a large language model or large multimodal models that generates responses based on natural language inputs provided by the user (such as through a query). In other examples, the system 100 may be configured to send API calls to other proprietary LLMs or LMMs to generate responses for the queries. The AI engine 112 may be configured to ingest and generate media files of other types based on the search results. For example, the AI engine 112 may ingest an image displayed on a first tile and generate a textual description to be displayed on a second tile.

In some embodiments, the AI engine 112 may be indicative of an autonomous agent. In such embodiments, the autonomous agent may be configured to execute a set of instructions (such as by making API calls) based on natural language text/inputs received from the user. For example, the user may instruct the system 100 to “change layout of the tiles”, the AI engine 112 may execute a set of API calls to change the arrangement of the tiles 110. Similarly, if the natural language text is “explain Kuleshov Effect”, the AI engine 112 may understand the instruction, and accordingly execute a set of API calls to one or more of the search engines, and select a subset of results from the search engines based on the user's requirements/preferences, as shown in FIG. 3I. The autonomous agent may allow the system 100 to understand and automatically execute steps required for realizing the user's request. Hence, the system 100 may allow for a multimodal search functionality that displays information/data for the user's queries in multiple media formats, and provide users with improved context.

In some embodiments, the system 100 may also be configured to generate/create web-based or software applications, such as websites, utilizing the tiles 110. The system 100 may ingest inputs from the user, which may include one or more (natural language) instructions for creating the application. The system 100 may decide on the number, size/dimensions, arrangement, and media types to be supported on one or more of the tiles 110. Further, the system 100 may determine the media artifacts to be presented on the tiles 110. Making such a determination may enable the tiles 110 of the multimodal interface to function as the desired application. For example, if the user provides natural language to “create a weather application” that displays current temperature, humidity, precipitation, and wind speed, the system 100 may create four tiles 110, each dedicated to displaying one of the four weather aspects.

The system 100 may include one or more hardware and software elements that allow the system 100 to perform the aforementioned functions/operations. Referring block diagram 200B to FIG. 2B, the system 100 may include the processor 102 associated with or residing within the system 100. The processor 102 may be implemented as one or more microprocessors, microcomputers, microcontrollers, digital signal processors, central processing units, logic circuitries, and/or any devices that process data based on operational instructions. Among other capabilities, the processor 102 may be configured to fetch and execute computer-readable instructions stored in a memory 204 of the system 100. The memory 204 may be configured to store one or more computer-readable instructions or routines in a non-transitory computer readable storage medium, which may be fetched and executed by the processor 102 for implementing the multimodal interface. The memory 204 may include any non-transitory storage device including, for example, volatile memory such as random-access memory (RAM), or non-volatile memory such as erasable programmable read only memory (EPROM), flash memory, and the like. The system 100 may also include an input/output(I/O) interface 206, configured to facilitate communication between the processor 102, and the memory 204. The interface 206 may also allow for communication with external devices connected to the system 100.

Further, the system 100 may include processing engine(s) 208 and the database 104. The database 104 may include data that is either stored or generated as a result of functionalities implemented by any of the components of the processing engine(s) 208. For example, the database 210 may store the media files, and other values and data structures resulting from operation of the processor 102. The processing engine(s) 208 may be implemented as a combination of hardware and software (for example, programmable instructions) to implement one or more functionalities of the processing engine(s) 208. For example, the processing engine(s) 208 may include processor-executable instructions stored on a non-transitory machine-readable storage medium, which are executed by a processing resource (for example, one or more processors). Examples of the processing engine(s) 208 may include a tile management engine 212, an interaction engine 214, an application interface engine 216, a generation engine, and other engine(s) 220. The other engine(s) 220 may implement functionalities that supplement applications/functions performed by the system 100. Each of the processing engine(s) 208 may be configured to perform at least one task of the system 100.

In some embodiments, the tile management engine 212 may be configured to receive/retrieve media files for display on the tiles 110. The tile management engine 212 may also be configured to resize and rearrange the tiles 110, and change the media types thereof. The tile management engine 212 may coordinate with the interaction engine 214 and the applications interface engine 216 to change the arrangement, size, and type of media files displayed on each of the tiles 110, based on the requirements.

In some embodiments, the interaction engine 214 may allow for tiles 110 to interact with each other. In some embodiments, the interaction engine 214 may allow the tiles 110 to have a resource locator associated therewith, to which the tiles 110 may send request messages through protocols known in the art.

In some embodiments, the applications interface engine 216 may allow the system 100 to communicate with external entities (such as the application server 160), and utilize response messages received from the entities to change or update the media files being presented in one or more of the tiles 110.

In some embodiments, the generation engine 218 may be configured to generate web-based applications or software applications, such as websites, using the tiles 110. The generation engine 218 may be configured to receive an input from the user, where the inputs may provide one or more instructions for generating the application. The generation engine 218 may determine at least one of number, size, arrangement, and media types to be supported on one or more of the tiles 110, and media artifacts to be displayed on the tiles 110. Such determination may allow the tiles 110 of the multimodal interface to operate as the intended application.

The system 100 may be adaptable to a plurality of contexts/situations. The implementations/applications of the system 100 (and the processing engines 208 thereof) are described in reference to FIGS. 3A to 3I. For example, the tile management engine 212 may allow a plurality of documents and forms associated with billings/invoicing, or tax filings to be opened simultaneously, as shown in FIG. 3A. Typical communications for the billing/invoicing between accountants and clients involve a number of different interactions. The multimodal interface 300A may combine all such interactions into a single interface, upon the completion of a tax return, for example. As shown, the first tile 302-1 may display a document including the tax return for review. The second tile 302-2 may enlist instructions for the client to follow. The third tile 302-3 may include an e-signature form (or interface therefor). The fourth tile 302-4 may include the invoice in PDF format. Presenting such media artifacts may allow the user to efficiently compare and confirm financial details, with minimal mental switching costs.

A further application may be in the financial industry for a user to carry out remote due diligence on its customers; a process known as electronic-Know Your Customer or “e-KYC”. In such examples, the first tile may allow the customer to shoot a video of themselves while following certain instructions, to verify that the video is real and recent. For instance, the customer may be instructed to move their head left and right, while holding a passport and/or the first page of a newspaper. The second tile may allow the customer to upload his identification documents (e.g., ID card, Proof of Residence, Bank reference letter, and the like). The third tile may include a set of questions for the user to complete their profile; for example, an appropriateness test or a knowledge test. The fourth tile may include information requested by the user/customer, or a document or tutorial video on the e-KYC process. All the information collected is then attached to the customer profile and stored in a database for further elaboration. The tile management engine 110 may be configured to arrange the tiles 110 and display the information in a predefined manner adapted for facilitating the e-KYC process.

In another application, the tile management engine 212 may provide contextual storytelling/journalism using the multimodal interface. For example, as shown in FIGS. 3B and 3C, a reporting of a tennis match may include videos (having highlights or clips of key moments in the tennis match) in the first tile 302-1, images in the second tile 302-2, and textual artifacts (such as news articles) in the third tile 302-3 of multimodal interface 300B, 300C. Since the multimodal interface is viewed on a smartphone in portrait mode (at least in the examples in FIGS. 3B and 3C), the tiles 110 may be stacked linearly, and accessible on scrolling. More tiles 110 may be provided by the tile management engine 212 to continue to narrate the details of the tennis match. The AI agent 112 may be configured to guide the user through each of the media artifacts.

Further applications may be in the context of e-commerce (such as for searching and comparing products, and storing them in electronic shopping carts), fitness (such as for guided training with tutorials for specific exercises), calendaring (such as temporarily displaying calendaring events in separate regions to show overlapped events), live news feed (such as presenting clips of the news channel in one tile, news articles on another, social media coverage on the event, and the like), chatbots, gaming (such as multi-player apps on separate tiles, competitions), and the like. By allowing multiple media files to be displayed concurrently, the system 100 enables users to access and interact with different forms of information, enhancing their overall experience and productivity.

In some embodiments, the tiles 110 may include at least one interactable element configured to display the media artifacts one an overlay window when the at least one interactable element is interacted with. For example, as shown in multimodal interface 300D of FIG. 3D, the tile 110 (which may be implemented as an employee card, brochure, concert card/ticket, and the like, which are configured to provide information on a single tile) may include the interactable element 304. The tiles 110 have multimodal interfaces 300D may be interchangeably referred to as ‘video cards.’ The video cards may be adapted for different use cases. For example, the video cards may be configured to display information about a musical concert using the multimodal interface, where the video cards may be configured to represent details such as venue, time, itinerary, terms and conditions, etc., as well as marketing and promotional information, e-commerce interface for selling merchandise of the persons involved in the musical concert, etc. The video cards may also be used for displaying personal information using the multimodal interface, such as personal information displayed on personal websites or business cards. Video cards may also be used to display information on a particular product using the multimodal format/interface. The video card 300D presented in FIG. 3D displays details and interactable elements associated with a cruise ship. The interactable element 304 may be clickable or selectable using the inputs provided by the user. On selecting the interactable element 304, the interaction engine 314 may be configured to retrieve data corresponding to the interactable element 304, and display the element over the overlay window 306 as shown in multimodal interface 300E of FIG. 3E. In some embodiments, when the media artifact on a first tile from the tiles 110 is associated with at least one of a URL or an AIDC, and the inputs indicate a request to access media contents associated with the URL or the AIDC means, the interaction engine 214 may be configured to retrieve the media contents, and display the media contents on a second tile. For example, when the interactable element is embedded with a URL, the interaction engine 214 may retrieve the corresponding data, and display the data on a second tile, instead of the overlay, thereby converting the tile 110 adapted for the video card interface into a multimodal interface.

In some embodiments, when the interactable elements 304 are interacted with, the system 100 may be configured to generate one or more tokens, and transmit one or more signals to the external entity or the other tiles indicating the generation of the one or more tokens, wherein the one or more tokens are configured to cause execution of a set of processor-executable instructions on being triggered. For examples, tokens (such as digital assets like cryptocurrency, utility tokens, etc., digital representations of credits, rewards, loyalty points, vouchers, discounts, coupon codes, commissions, and the like) may be generated when interactable elements 304 of a video card are interacted with. Such video cards may be used by including, but not limited to, sales persons, referral associates, and the like, who may receive commissions each time a customer interacts with the interactable elements (such as for purchasing a product). The commissions may be received in the form of tokens that may be configured to cause the execution of processor-executable instructions. In some embodiments, the tokens may cause processor-executable instructions on being triggered by at least one of: being decoded, (asymmetrically) decrypted, verified, transferred/transmitted to another entity, and the like, but not limited thereto. The set of processor-executable instructions may be any set of instructions executable by a processor. For example, the token may include a digital stamp that may be decoded and recognized as electronic proof of a successful sale by the sales persons. In other examples, the tokens may be converted into discount codes for the users/customers, who may use the code for availing further discounts.

In some embodiments, the video cards may also be implemented along with the AI engine 112, which may be configured to perform at least one of: narrating the media artifacts being displayed on the video card, receiving inputs (such as questions, complaints, or queries), and generating responses therefor in natural language, retrieving external information pertinent to the media, and the like, but not limited thereto. In some embodiments, the AI engine 112 may include at least one conversational AI agent, which may include at least one model or a set of models configured to hold natural language conversations with the users. Further, the conversational AI agent may be adapted to address queries of or guide the users through the media artifacts in the video cards/tiles 110, such as by generating natural language texts or audio. In some embodiments, the conversational AI agents may be adapted (such as through training or finetuning) based on the media artifacts and the context of the video cards. For example, when the video cards are implemented for a concert/event ticket or a brochure, the conversational AI agents may be adapted for escorting the users through the venue, guiding the user through parking spaces, information the users of the itinerary of the events, etc. In other examples, the conversational AI agent may be adapted to behave as a companion for the users to provide for in-context entertainment and/or assistance. The operations of the AI engine 112 on the tiles 110 are described in further detail subsequently in the present disclosure.

The interaction engine 214 may be adapted for any task where the tiles 110 send or receive a data or information flow to or from each other. In the example shown in multimodal interface 300F of FIG. 3F, where the multimodal interface 300F is used for providing a gaming interface, the first tile 302-1 may provide instructions on scoring points (according to rules of the game). The second tile 302-2 may display a video of an equestrian racing event when the user places bets on a particular horse. The third tile 302-3 may include a tennis match where the user predicts or guesses which player wins the next point, game, or the set. The fourth tile 302-4 may display a questionnaire where the user provides textual inputs for a list of questions. the questionnaire may be associated with a marketing campaign initiated by any sporting organization, and may include incentives/rewards for the user. Once a predetermined time period is complete, the first tile 302-1 may receive information/data from all other tiles (such as bets placed in second tile 302-2 and the results of the racing event, guesses made in the third tile 302-3 and results thereof, and the text inputs provided in the fourth tile 302-4). The information may be shared through the interface provided between each of the tiles 110/302. The first tile 302-1 may process the information, and generate a score indicating how successful the user was in betting, and answering questions in the questionnaire. In other applications, the interaction engine 214 may enable data merges between two or more media types, such as sending emails using an emailing service provider to all emails in an email list (such as those provided in a list data structure, database or a Comma Separated Value (CSV) file, for example).

In further applications, as shown in multimodal interface 300G of FIG. 3G, multimodal interface 300G may be used for displaying property/housing/real estate loans/lending information. For example, the user may operate the second tile 302-2 to select and view the property. The first tile 302-1, the third tile 302-3, and the fourth tile 302-4 may allow the user to fill load applications forms, explore lending schemes applicable, and calculate mortgage rates, respectively, for the property selected in the tile 302-2. In such examples, the interaction engine 214 may allow communication of the property selected by the user in the second tile 302-2 to other tiles, and accordingly retrieve the corresponding loan or mortgage information associated with the selected property to be displayed in the other tiles.

Additionally, the application interface engine 216 may be adapted for any task requiring data to be retrieved and processed for display on the tiles 110, such as for retrieving and/or analyzing stock prices, weather, user interactions, voting, and the like. In an example, when the stock chart/price of a listed company in the first tile changes, changes or notifications are sent to the second tile to process and indicate the change to the user. The user may open a third tile having a bank or a brokerage house may provide interfaces on a website to allow transactions to be executed

Another application may be in healthcare, such as in the example shown in multimodal interface 300H of FIG. 3H. A unique QR code may be provided on a package of pharmaceuticals. In some embodiments, the QR code may be scanned to retrieve data therefrom. The data may either include information on the drug, or a URL that has the information on the drug. The data from the QR code may be processed by the system 100 in the case of the former, or sent to the application server 160 by the application interface engine 216 to retrieve information from the URL in case of the latter. Upon scanning the package, the system 100 may display a variety of elements in the multimodal interface 300H that may include a drug disclosure form with side effects on the first tile 302-1, a tutorial video on how to inject/consume the medicine in the second tile 302-2, a video about the manufacturer on the third tile 302-3, and a website of the retailer or drug company on the fourth tile 302-4. Once the drug has been purchased (and QR code scanned at point of sale), the nature of some tiles of the 110 may change, for example, to a customer service portal of the drug company, a digital receipt, and/or a therapy group relevant to the drug purchase. The updated tiles 110 may be accessed via the same QR code on the packaging, or part of a multimodal receipt sent to the customer. The application interface engine 216 may, thereby, allow the system 100 to communicate and retrieve information from entities external to the network architecture, which is further used for providing users with a more comprehensive and/or holistic presentation of request information.

Another application may be in provision of product data, such as in relation to the supply chain journey from inception/manufacturing, to purchase, to consumer ownership and recycling. In such applications, unique QR code (or other AIDC means) may be provided on the packaging and or the product itself, thereby creating a digital passport that records and acts as the gateway to a wide number of interactions across a product's journey and lifetime. In some embodiments, the QR code may be scanned to retrieve data therefrom. The data may either include information on the product, animal, or object, or a URL that has the information on the product, animal, or object. Data may include product origin, materials, breeding data, environmental impact information, supply chain insights, disposal guidelines, gaming, promotions, and any other relevant data or interactive options/interactable elements, for example. The data may be displayed on the multimodal interface provided by the system 100. In some embodiments, the data from the QR code may be processed by the system 100. Further, interaction with the interactable element may cause signals to be transmitted to the application server 160 by the application interface engine 216 to retrieve information from the URL. In some examples, on scanning the AIDC means, the system 100 may display a variety of elements in the multimodal interface, which may include a warranty form on the first tile, a tutorial video on how to use the product in the second tile, a video about the manufacturer on the third tile, and a website or promotion of the retailer on the fourth tile 302-4. Once the product has been purchased (and QR code scanned at point of sale), the nature of some tiles of the 110 may change, for example, to a customer service portal of the company, a digital receipt, and/or a gaming promotion relevant to the product purchase. The updated tiles 110 may be accessed via the same QR code on the packaging or product, or part of a multimodal receipt sent to the customer. The application interface engine 216 may, thereby, allow the system 100 to communicate and retrieve information from entities external to the network architecture, which is further used for providing users with a more comprehensive and/or holistic presentation of requested information. Further, the AI engine 112 may also be configured to adapt to the context of the user/customer. For example, the AI engine 112 may be configured to adapt its operations based on which point/stage in the product supply lifecycle that the customer is in.

In some embodiments, scanning and media display systems that scan the AIDC means and display content assigned to the AIDC means, such as those described in the applicant's U.S. patent application Ser. No. 17/210,503, U.S. patent application Ser. No. 18/541,374, and Indian Patent Application No. 202118001428, may be adapted to present the multimodal interface of the present disclosure. For example, the video cards or other multimodal interfaces may be made available on scanning or accessing the AIDC means. In examples where the AIDC means are attached to the product (such as an article of clothing, physical objects, sports apparel, and the like), which, when scanned, may redirect the user to a multimodal interface adapted to present media artifacts that are relevant to the product. In some applications, the AIDC means on the products may be configured to redirect to multimodal interfaces implementing gaming features, such as those requiring interaction between the tiles 110 (as described in the present disclosure), apart from presenting information on the product. Such games may be implemented as a part of marketing campaigns. In other applications, the multimodal interfaces may be configured to allow the users/customers to scan the AIDC means to interact with, upload content, and share stories/experiences about the product, object, or animal to which the AIDC means may be attached. For example, the AIDC means may be deployed in on apparel, purses, souvenirs, automobiles, bicycles, restaurant walls, jewelry, pet collars, and the like, which may redirect the users who scan the AIDC means to the multimodal interface adapted to operate as an appreciation wall, maintenance record, associated memories and experiences, multimodal archive, or a social media profile that allows the users to view, interact, and leave multimodal messages (i.e., in text, audio, video, images, and the like).

In a further application, the system 100 may provide a multimodal search feature/functionality. In the example shown in multimodal interface 300I of FIG. 3I, the system 100 may receive natural language inputs from the user through a query text box in the multimodal interface 300G. The queries may be sent to one or more search engines through the application interface engine 216. The search engines may return search results in the form of media files. The AI engine 112 may receive the search results and select a subset of results to be displayed in the tiles 302-1 to 302-4. The selected search results may include text documents, images, videos, and other media formats. The results may be selected based on user preferences. For instance, the AI engine 112 may select the search results of different media types conducive to the user's learning/understanding. If the user prefers to view one result of each media type, the AI engine 112 may analyze the results returned by all the search engines, and select a combination of results of different media types that provide complementary information related to the query. The selected search results may be presented in the tiles 302-1 to 302-4, allowing the user to view different media related to their query simultaneously. For instance, the AI engine 112 may select and display PDF documents in the first and second tiles 302-1, 302-2, and videos in the third and fourth tiles 302-3, 302-4. While the PDF documents may describe the Kuleshov effect, the videos may provide examples of the same, thereby providing greater context and allowing the user to engage visual, audio, and mental faculties to view and understand the queried subject. The multimodal search functionality may, hence, enhance the user's search experience by providing them with a more comprehensive view of the search results in different media formats.

While the foregoing examples/applications provide specific use cases for the multimodal interface, it may be appreciated by those skilled in the art that the system 100 may be adaptable to a wide range of contexts and applications, and may not be limited to the aforementioned. The system 100 provides a flexible and interactive platform/interface that allows users to view, interact with, and compare multiple media files concurrently. By presenting media files concurrently, the system 100 enhances the context and understanding of the information being presented, leading to improved user experience and efficiency. The multimodal interface also allows for interaction between the media files and external applications, further expanding the capabilities and functionality of the system 100.

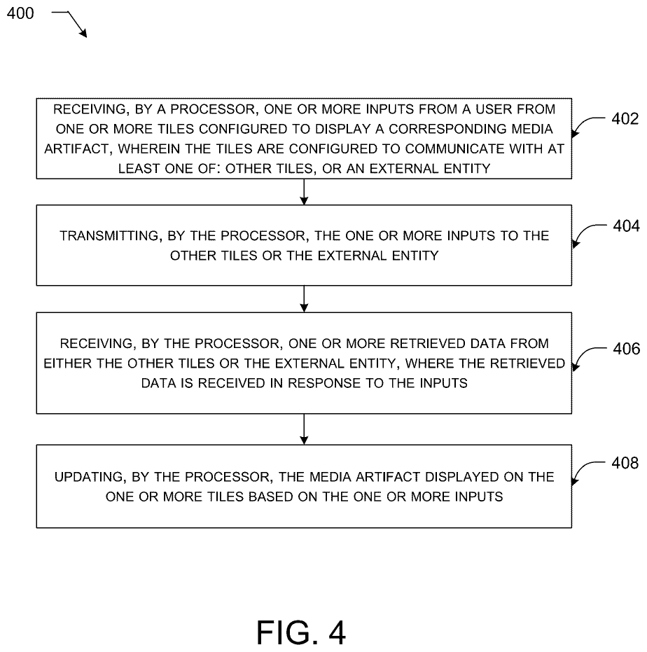

FIG. 4 illustrate flowcharts of an example methods 400 for enabling interaction between the tiles 110 and interaction of the tiles 110 with external entities, in accordance with embodiments of the present disclosure. In some embodiments, the system 100 may be configured to implement the methods 400.

The method 400 for enabling interaction between the tiles 110 may be implemented when values/content in each of the tiles 110 is dependent on one another. At step 402, the method 400 includes receiving, by a processor such as processor 104 of FIGS. 1A and 2A, one or more inputs from a user through one or more tiles, such as tiles 110 of FIG. 1A, configured to display a corresponding media artifact. The tiles 110 may be configured to communicate with at least one of other tiles or external entities. At step 404, the method 400 includes transmitting, by the processor, the inputs to the other tiles or the external entity. In some embodiments, a first tile may communicate with the other tiles or the external entities when the user provides an input to the first tiles, or there is an update in any value/content in the first tile. At step 406, the method 400 includes receiving, by the processor, one or more retrieved data from either the other tiles or the external entity. The other tiles or the external entities may be configured to retrieve and transmit the retrieved data in response to the inputs. The retrieved data may correspond to the data either retrieved by the external entities (such as the application server 160), or data processed by the other tiles of the multimodal format. At step 408, the method 400 may include updating, by the processor, the media artifact displayed on the one or more tiles based on the inputs received from the users. At least one of: a media type assigned to the first tile, number, size, position, and arrangement of the first tile, or contents of the first tile, may be updated based on the inputs.

In some embodiments, when the inputs are communicated to the other tiles or the external entity, the method 400 may further include processing the retrieved data using an AI engine, such as the AI engine 112 of FIG. 1A, and updating the media artifacts displayed in the tiles 110 based on the one or more retrieved data processed by the AI engine 112. For example, the AI engine 112 may be configured to curate search result artifacts received from external entities indicative of search engines. The curated search result artifacts may be organized and arranged for presentation on the tiles 110 of the multimodal interface.

It will be appreciated that the steps described above may be performed in a different order, varied, or some steps omitted entirely without departing from the scope of the present disclosure.

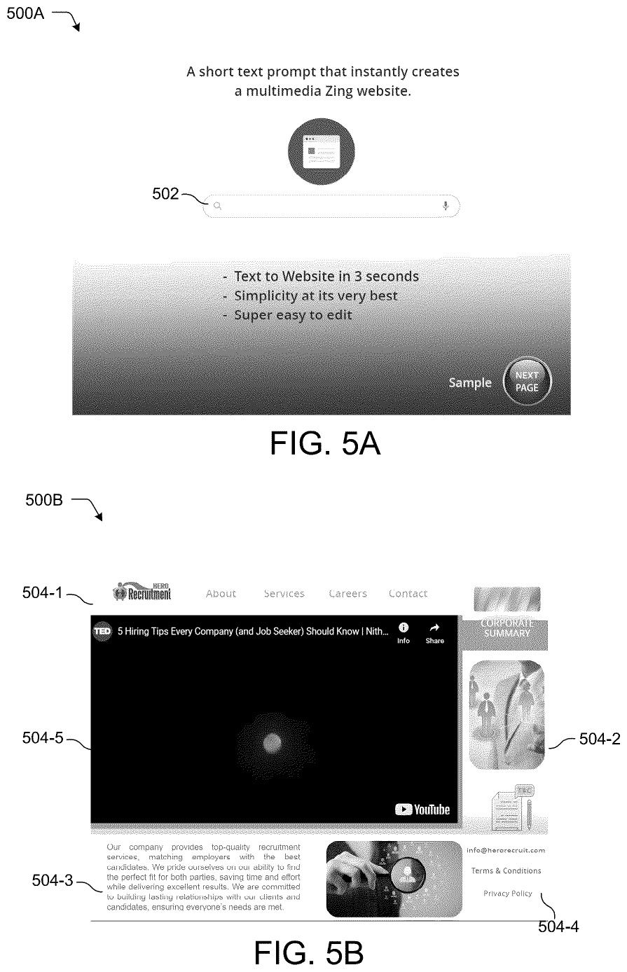

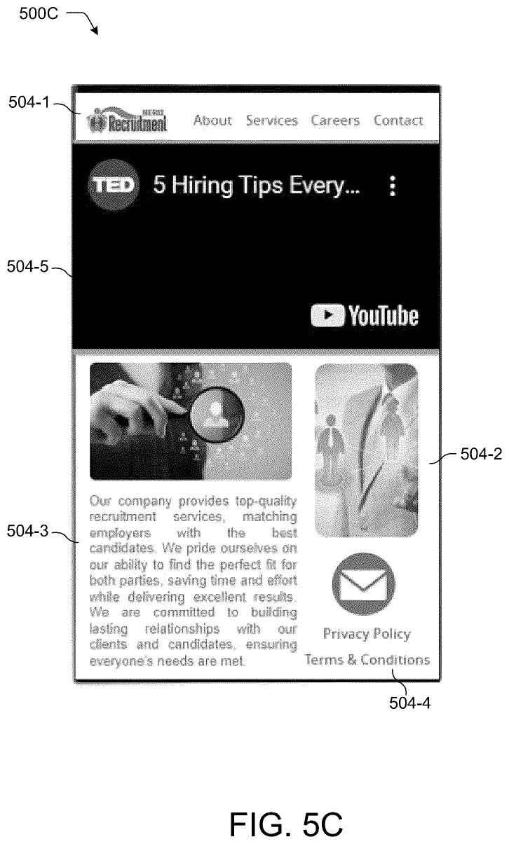

The system 100/the generation engine 218 may also be configured to generate web-based applications or software applications, such as websites or online multimodal games, using the multimodal interface. The application may be generated based on inputs provided by the user, as shown in FIG. 5A. The multimodal interface 500A may provide an input box 502 to receive inputs from the user. The input box may receive in the form of any one or combination of text, image, audio, video, or the like.

The system 100/generation engine 218 may be configured to determine at least one of number, dimensions, arrangement, media types, of the tiles 110. Such parameters may be determined based on the inputs. In some embodiments, a template may be retrieved from a database based on the inputs, where the template includes such parameters associated with the tiles 110. In some embodiments, the system 100 may either determine such parameters or select the template using the AI engine 112, based on the inputs. In an example shown in FIG. 5A, the input box 502 may receive textual or audio inputs, where the user may request the system 100 to generate a recruitment website.

In some embodiments, the system 100/generation engine 218 may either generate or retrieve, using the AI engine 112, media artifacts to be displayed on the tiles 110. In embodiments where the media artifacts are generated, the AI engine 112 may be trained to generate and/or retrieve the media artifacts based on the inputs. In embodiments where the media artifacts are retrieved, the inputs may be used for querying either one or more search engines (such as through the application server 160) or a database (such as the database 210) for media artifacts. Such media artifacts may be displayed on the tiles 110. In some embodiments, the AI engine 112 may be configured to select the media artifacts for display on the tiles 110, which may be based on the template select, instructions provided by the user, or a set of predetermined heuristics (such as design principles) that make the presentation of the media artifacts intuitive for other viewers.

In the example shown in FIG. 5B, the multimodal interface 500B may include tiles 504-1 to 504-5 arranged in a predetermined layout. As shown, the first tile 504-1 may include a header having links to other pages/tiles of the website, along with a name and logo. The second tile 504-2 includes a side menu with one or more vector graphics to improve aesthetics. The third tile 504-3 includes a text describing the details of the organization operating the website made from the multimodal interface 500B. The fourth tile 504-4 may include contact information, and links to other tiles providing legal information. Further, the fifth tile 504-5 may include a video embedded therein. Other tiles may be hidden, and may be displayed when clicked/accessed by the viewers of the website. Viewing the hidden tiles may either cause the layout to change, or open as a pop up overlayed on the website. Further, since the tiles 110 allow media artifacts to be presented in any layout, the tiles 110 may be dynamically reformatted based on the device being accessed, as shown in multimodal interface 500C in FIG. 5C. While the example shows a website with minimal interactivity (i.e. where the media artifacts are substantially static), it may be appreciated by those skilled in the art that the tiles 504 may be suitably adapted to include interactable media files (such as buttons that perform a predefined function such as executing a purchase of an item, or a video game where a character moves across the screen on being provided with inputs), based on the requirement of the software application.

Optionally, the system 100 may host the application on a unique URL, thereby making the application accessible through the internet. In some embodiments, the system 100 may generate a URL for the application for allowing access to the website. In other embodiments, the system 100 may allow other means to access the application/website.

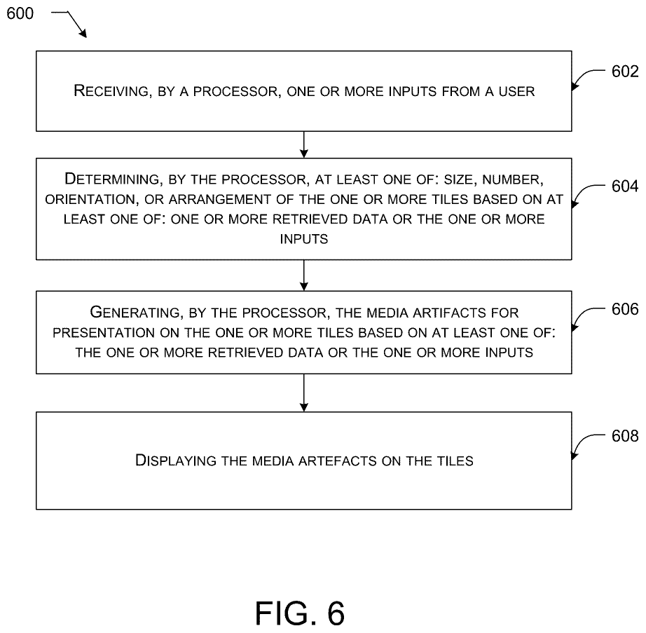

FIG. 6 illustrates a flowchart of example method 600 for generating web-based applications or software applications, such as websites, using the multimodal interface, in accordance with embodiments of the present disclosure. In some embodiments, the system 100 may be configured to implement the method 600.

At step 602, the method 600 includes receiving inputs from the user. The inputs may be in the form of any one or combination of natural language texts, images, audio, video, biometric, or the like. At step 604, the method 600 includes determining at least one of size, number, orientation, or arrangement of the one or more tiles based on at least one of the retrieved data or the inputs. In some embodiments, such determination may be made using the AI engine 112. The AI engine 112 may also determine the properties of the tiles 110 based on the media artifacts to be displayed on the tiles 110 or retrieved data from other tiles or external entities. In some embodiments, a template may be retrieved from the database 104 based on the inputs, where the template includes such parameters associated with the tiles 110. At step 606, the method 600 includes generating or retrieving, using the AI engine 112, media artifacts to be displayed on the tiles 110 based on at least one of the retrieved data or the inputs. At step 608, the method 600 includes displaying the generated/retrieved media artifacts on the tiles 110. Optionally, the method 600 may include hosting the application on a unique URL, thereby making the application accessible through the internet.

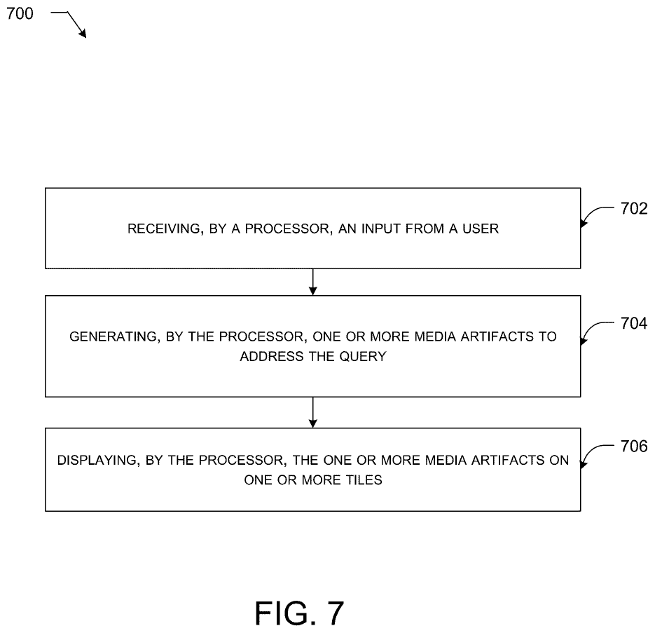

In some embodiments, the AI engine 112 may be configured to generate, curate, and guide users through multiple media artifacts to address queries raised by the user. In some embodiments, the system 100 may be configured to implement method 700 shown in FIG. 7. At step 702, the method 700 includes receiving, by a processor, an input from a user. The query may be in the form of natural language text, image, video, audio, biometric, and the like, as described previously in the present disclosure. At step 704, the method 700 includes generating, by the processor, one or more media artifacts to address the input. In some embodiments, for generating the one or more media artifacts, the method 700 may include retrieving the media artifacts from the database 104 or external entities. In other embodiments, the method 700 may include processing the retrieved media artifacts to generate further media artifacts using the AI engine 112. In further embodiments, the method 700 may include generating the media artifacts based on the input.

At step 706, the method 700 may include displaying, by the processor, the media artifacts on the tiles 110 associated with a multimodal interface. For displaying the media artifacts, the method 700 may be configured to display a first subset of media artifacts sequentially, and a second subset of media artifacts concurrently, as may be determined by the AI engine 112. In some embodiments, for displaying the media artifacts, the method 700 may include determining, by the processor, an order of displaying the media artifacts on the tiles 110, such as when the media artifacts are displayed sequentially. Further, the method 700 may include determining, by the processor, at least one of: size, number, orientation, or arrangement of the tiles 110 for displaying the media artifacts. In some embodiments, the method 700 may include displaying the media artifacts in the same computing device used by the users to provide the inputs, or on a different computing device. In some examples, the system 100 implementing the method 700 may be configured to receive the inputs and display the generated media artifacts on the same computing device (i.e. the user's device), such as in telemedicine applications. In other examples with medical applications, the system 100 may be configured to receive the inputs from the user's/patient's device, the media artifacts generated by the system 100 may be displayed on healthcare provider's device. Similarly, in recruiting applications, the system 100 may receive inputs from the user indicative of an interviewee, and display the media artifacts on the recruiter's device.

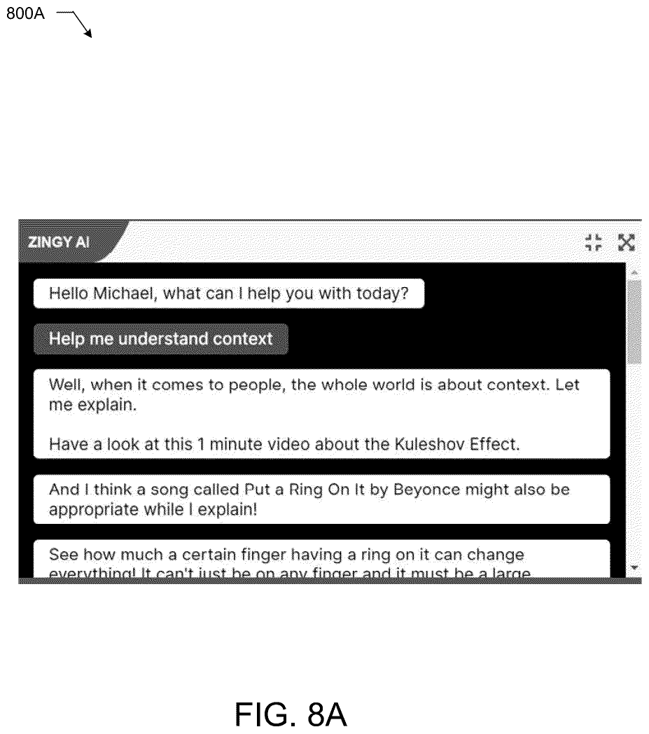

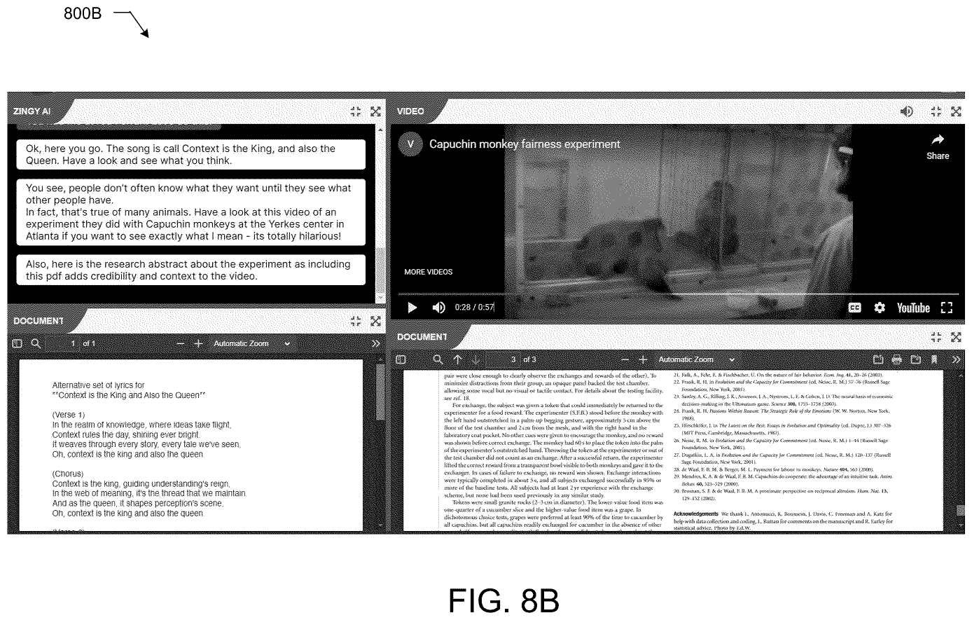

Examples where the method 700 may be implemented are described in references to FIGS. 8A and 8B. As shown in multimodal interface 800A of FIG. 8A, an interface may allow users to provide inputs or queries to the system 110 (such as a chat interface). The input may be to describe the concept of “context”. The system 110 may receive the query, and generate a natural language media artifact to response to the query, such as using the AI engine 112, which may be a large multimodal model or an autonomous agent. Further, the system 110 may be configured retrieve one or more of the media artifacts from external entities (such as by executing API calls to different search engines), to retrieve examples to describe the concept of context. For example, the AI engine 112 may retrieve the media artifacts corresponding to the “Kuleshov effect”, as shown in FIG. 3I. The system 110 may be configured to instantiate one or more of the tiles 110 based on the determination of at least one of: size, number, orientation, or arrangement for the tiles 110 based on the media artifacts generated and/or received. The AI engine 112 may be configured to process the media artifacts generated or retrieved, and curate those media artifacts for display which may be conducive of the user's interests and preferences. Further, the AI engine 112 may also provide resize and reorient the tiles 110 for presenting the media artifacts. As shown in multimodal interface 800B of FIG. 8B, the system 100 may provide further examples for context. For example, the AI engine 112 may curate a video (such as of the Capuchin Monkey Fairness experiment), and a textual document (i.e. the corresponding research paper describing the experiment), for display on the tiles 110, thereby conveying that providing multimodal interfaces for presenting information improves context. Further, the AI engine 112 may also be configured to generate audio artifacts to narrate the contents of the media artifacts presented in the tiles 110.

In some embodiments, the steps of the method 700 may be iterated in real time. In such embodiments, the AI engine 112 may be implemented as a conversational agent. In some examples, the multimedia interface may be used in a call center environment. In such examples, an AI engine 112 associated with a call center may engage in an audio or a video call with a customer. The multimodal interface may include a first tile configured to host an audio or a video conferencing means. The AI engine 112 may use the conversational AI agent to converse with the user by generating at least one of audio, video, or textual artifacts based on user inputs on the first tile. The AI engine 112 may be configured to process the inputs from the first tile to analyze sentiment, tone, facial expressions, and the like, of the customer, thereby allowing the conversational AI agent to receive feedback on the customer's mood and emotion, among others, and accordingly conduct the conversation. The AI engine 112 may also be configured to retrieve/search and display information that may be relevant to continue the conversation and resolve the issues/complaints/queries raised by the customers/users on a second tile, such as media artifacts indicative of self-resolution tutorials, for example. In such examples, the system 100 may allow inputs to be received from the users, processed (such as by the AI engine 112), and displayed on the tiles 110 iteratively, and in real time. By iteratively taking turns to receive the inputs and generate responses, the system 100 may provide an interactive/conversational experience to the user/customer.

In some embodiments, the system 100 may be adapted for medical applications. In some embodiments, the system 100 may be used for telemedicine applications, such as for performing physical and/or mental health checkups remotely and automatically. For example, the system 100 may be implemented as a mental health checkup application. The system 100 may be configured to receive inputs from the users. The inputs may be received in the form of natural language inputs (such as in text, audio, or video) or biometric data (such as heart rate, facial expressions, skin tone, and the like, which may be determined by the AI engine 112). In some examples, the AI engine 112 may analyze the inputs to detect indicators associated of mental health states, such as sentiment, stress levels, or mood fluctuations. Based on the analysis, the system 100 may be configured to identify one or more potential symptoms for the mental health state, and generate and/or retrieve various media artifacts, such as relaxation videos, motivational messages, or relevant articles, and display them on the tiles 110 to address the mental health state. The system 100 may also provide real-time communication with mental health professionals through video or audio conferencing embedded in the tiles.

In some embodiments, multimodal inputs may be collected from the users. For example, video and audio inputs may be collected from the user to identify any symptoms, such as based on skin color, skin tone, asymmetry in face, irregularity in speech, etc. In some embodiments, the inputs may also include biometric inputs, which may be used to uniquely identify the users/patients. For example, the biometric inputs, such as iris scans, fingerprints, tonal biometrics, facial biometrics, and the like, may be used to identify the users/patients, and retrieve medical records thereof. In some embodiments, the AI engine 112 may also be configured to analyze the inputs, and (generate and) transmit audio signals to the request more inputs from the users, such as by asking questions using a conversational AI model.

In some embodiments, the AI engine 112 may also be configured to perform diagnosis based on the multimodal inputs from the users. In such embodiments, the AI engine 112 may be configured to identify one or more potential symptoms based on the inputs (such as using the classifiers associated with the AI engine 112). The input may be received in natural language, such as by way of answering a question raised by the AI engine 112. For example, for performing psychometric tests to determine mental health/mental state of the patient, the AI engine 112 may be configured to ask (through audio signals or textual outputs on the tiles 110) the user/patient a set of predefined questions, and process the audio/text inputs received from the user/patient to determine their mental health or states. The potential symptoms may also be identified based on the multimodal inputs for the user (such as determining an estimate of the patient's pulse through video inputs, determining if the patient is intoxicated or inebriated, determining symmetry of the face to determine (onset of) stroke, and the like). The AI engine 112 may use the conversational AI agent to ask questions, and use other inputs from the user to perform tests and identify potential symptoms concurrently.

In some embodiments, the inputs from the users may be collected by the conversational AI agent. For example, the conversational AI agent may be configured to ask users/patients a set of predefined questions, which may help assess the mental health status of the users. The conversational AI agent may take a conversational tone, and/or may adapt the questions to suit the personality and preferences of the user as well as the context in which the telemedicine application is being used. The conversational AI agent of the AI engine 112 may be customizable. For example, the user/patient may be able to select/customize (or otherwise generally adapt) the personality of the conversational AI agent based on needs and preferences. The conversational AI agent may be adapted to indicate medical evaluations in general conversations. The conversational AI agent may be configured to process the media artifacts being viewed by the user, and adapt those media artifacts and integrate mental health assessments. In such examples, the mental health assessments may be seamlessly integrated into the media artifacts being consumed by the users in different contexts. Further, in telemedicine applications, the mental health tests may be designed and adapted for convenient use on multimodal interfaces/formats. Hence, the system 100 may be able to provide scalable telemedicine services to the users using the multimodal interface of the present disclosure.

The AI engine 112 may be configured to match the potential symptoms with one or more potential diagnoses. For example, the AI engine 112 may be configured to use a scoring algorithm that aggregates the probabilities assigned to the potential symptoms by the classifier, and determines the potential diagnoses based on the probabilities of each of the potential symptoms. In other examples, the AI engine 112 (being an autonomous agent) may be configured to filter a set of diagnoses stored in a database (such as database 104) based on the identified potential symptoms. While the examples above describe the medical/telemedicine applications in reference to mental healthcare, it may be appreciated by those skilled in the art that the system 100 may also be suitably adapted for providing ‘physical-health’ care. For example, the system 100 may be configured to instruct the patients/users to perform a set of physical examinations, such as performing straight leg raises for diagnosing sciatica. Based on video inputs from the user, the system 100 may be configured to determine if the user is performing the physical examinations correctly, using the AI engine 112. The AI engine 112 may provide feedback to the users for correcting form. Based on whether the user complains pain when performing the physical examinations, for example, the AI engine 112 may identify provocative movements, and determine a diagnosis. Further, the AI engine 112 may be configured to generate media artifacts based on the diagnosis, such as physical therapy treatments, diet prescriptions, exercise tutorials, health care professional recommendations, and the like.

The system 100 may be configured to display the media artifacts associated with the potential diagnoses on the tiles 110. The media artifacts may include other tests that may be performed by the users, alerts for emergency care, prescriptions and treatment options for the user/patient, and the like, but not limited thereto. The media artifacts may also be suitably adapted based on the requests. For example, if the user is the patient, then the media artifacts may provide simple descriptions of the diseases. If the user is a healthcare provider, the media artifact may include patient's medical history, research papers on the potential diagnoses (which may be clinically confirmed), treatment options, prescription for medications, and the like, but not limited thereto. Since the tiles 110 may be configured to communicate with external entities, at least one of the tiles may be configured to transmit signals having the user/patient's details to the application server 160, where the application server 160 may have medical records of the patient. The application server 160 may also be operated by the healthcare provider, and may be configured to use the user/patient's details for administrative purposes.

In some embodiments, the system 100 adapted for medical applications or telemedicine may be implemented as a software application or a web-applications installable on a smartphone, laptop, desktops, special-purpose computing devices, consoles, and the like. The system 100, in other embodiments, may be accessible through corresponding URL or AIDC means. Further, in such embodiments, at least one a first tile may be configured to receive multimodal inputs from the user/patients through, in response to one or more preset questions presented on the tiles 110. For example, when installed at a reception of clinic, the patient/user may use/scan the URL or AIDC means displayed on the reception to access the system 100 (or the multimodal interface adapted into a clinic form). The system 100 may retrieve and present a clinic form on the first tile. The clinic form may be used to receive information from the users for, among other things, administrative purposes, prioritize patient care based on symptoms, retrieve past medical information associated with the patient, etc. In such applications, the use of multimodal inputs from the multimodal interfaces may allow for a comprehensive assessment of the patients. Further, the use of autonomous entities such as the AI engine 112 may allow the system 100 to be easily scalable, thereby enabling easier access to healthcare, improving preventative care and early prediction of onset of diseases, and lowering time and costs of making diagnoses (as predictions of the AI engine 112 can be stored in a database for future access), among other advantages.

In some embodiments, the inputs from the users may be data associated with animals, such as a pet, horse, farm animal and the like. The data may be related to sports, livestock and/or veterinary services for animals, but not limited thereto. The inputs may involve the animal in isolation or in conjunction with a human and be collected by the conversational AI agent. For example, the conversational AI agent may be configured to ask users/patients a set of predefined questions about the pet, along with instructions to position the animal in such a way to gather further media artifacts which may help assess the fitness and health status of the users and animals alike. In other examples, a video camera positioned inside the stall of a racehorse, paddock for livestock, or pet kennel or home monitoring system for pets. Such inputs may be received by the system 100, and processed/analyzed by the AI engine 112, which may generate further media artifacts based on the processed inputs. Such inputs may be analyzed for applications in including, but not limited to, telemedicine for animals, automated diagnoses, improved interaction with the animals, and the like. For example, the system 100, being implemented on general purpose devices such as smartphones or laptops, may allow the animals to be tested and diagnosed for diseases remotely, thereby eliminating the need (and stress) associated with the taking the pets to veterinaries, waiting in lines, waiting with other animals which may further cause stress to the animals/pets, etc. In some embodiments, the personality of the conversational AI agent in the veterinary telemedicine may be trained/adapted based on animal needs, breeds, and preferences.

In some embodiments, when the multimodal interfaces are accessible on scanning AIDC means, such multimodal interfaces may be preconfigured to display a predefined set of media artifacts. In some applications, the AIDC means (such as a QR code) may be attached to the collar or other clothing of the pet/animal. The predefined set of media artifacts may include information such as name, breed, age, details of owner, medical history, triggers of the animal/pet, and the like.

The system 100 may also have applications in recruiting. For example, the system 100 may be configured to autonomously conduct interviews of interviewees/users. In some embodiments, the system 100 may be configured to receive inputs from the users. The inputs may be in multimodal form, i.e. in the form of any one or combination of text, image, audio, video, biometric, and the like, as described earlier in reference to other examples. The AI engine 112 may use the conversational AI agent to interact with the user, such as to ask questions and receive answers therefor. In some embodiments, the interaction between the AI engine 112 and the interviewee may take place on a first multimodal interface, such as those on the devices used by the user/interviewee. In some examples, a first tile may include a chat interface that is connected to the conversational AI agent, which may provide instructions to interact with other tiles as a part of the assessment. The conversational AI agent may also generate other textual and/or audio signals to instruct the interviewees through the assessment process. For example, the conversational AI agent may be configured to instruct the interviewee to upload resume and other personal details on a second tile, answer questions displayed on a third tile, attempt interactable aptitude tests displayed on a fourth tile. The interaction between the user/interviewee and the system 100/AI engine 112 may include iteratively receiving the inputs from the user through the first multimodal interface, and transmitting, from the system 110, one or more instructions (such as the instructions described above) generated by the AI engine 112 based on the inputs.

The system 100 may be configured to determine one or more assessment values based on the inputs and the instructions. The assessment values may be determined using any one or more combination of methods/techniques known to those skilled in the art. The assessment values may be any of including, but not limited to, percentages, percentiles, numeric scores, grades, categorical values, graphs, and the like. In some embodiments, the AI engine 112 may be used to determine the assessment values. In some examples, the inputs (such as video feeds) received in response to instructions (such as questions raised by the AI engine 100) from the system 100 may be processed to determine the assessment values.

In some embodiments, the system 100 may include displaying the assessment values on a second multimodal interface. In some embodiments, the second multimodal interface may be the same as the first multimodal interface, such as when the system 100 is used for mock interviews or mock assessments. In other embodiments, the second multimodal interface may be different from the first multimodal interface when the first multimodal interface is used by the users/interviewees and the second multimodal interface is used by the recruiters.

In some embodiments, the system 100 may be configured to generate multiple media artifacts based on at least one of the inputs, the instructions, and/or the assessment value. For example, graphical representations of the assessment values may be generated by the AI engine 112. Such media artifacts may then be displayed on the second multimodal interface for the recruiters to view and make decisions. In such applications, the use of multimodal inputs from the multimodal interfaces may allow for a comprehensive assessment of the interviewees (or generally assess-ees or candidates). Further, the use of autonomous entities such as the AI engine 112 may allow the system 100 to be easily scalable, thereby allowing recruiters to perform assessments at a larger scale more efficiently with reduced time and cost.

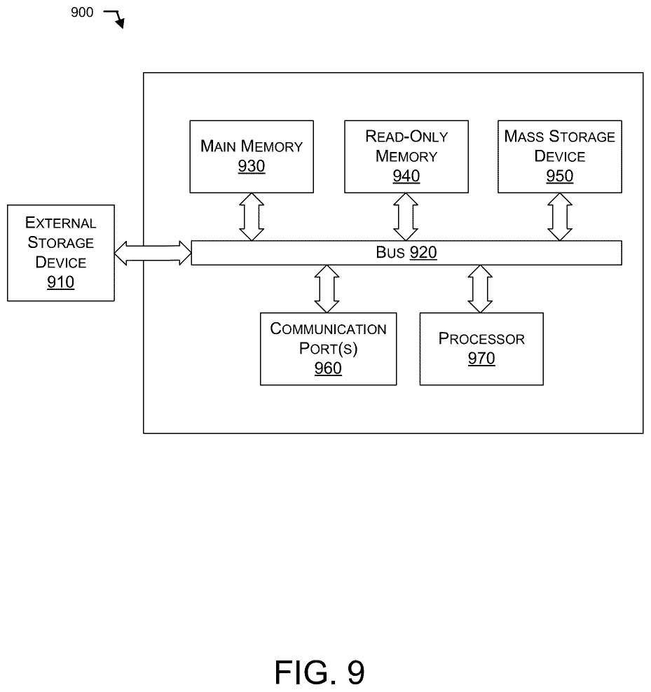

The system 100 may be implemented in a computer system. Referring to FIG. 9, the block diagram represents a computer system 900 that includes an external storage device 910, a bus 920, a main memory 930, a read only memory 940, a mass storage device 950, a communication port 960, and a processor 970. A person skilled in the art will appreciate that the computer system 900 may include more than one processor 970 and communication ports 960. The processor 970 may include various modules associated with embodiments of the present disclosure. The communication port 960 can be any of a Recommended Standard 232 port for use with a modem-based dialup connection, a 10/100 Ethernet port, a Gigabit or 10 Gigabit port using copper or fiber, a serial port, a parallel port, or other existing or future ports. The communication port 960 may be chosen depending on a network, such as a Local Area Network (LAN), a Wide Area Network (WAN), or any network to which computer system 900 connects.

In an embodiment, the memory 930 can be a RAM, or any other dynamic storage device commonly known in the art. The Read-Only Memory (ROM) 940 may be any static storage device(s) e.g., but not limited to, a Programmable Read-Only Memory (PROM) chip for storing static information. The mass storage 950 may be any current or future mass storage solution, which may be used to store information and/or instructions. Exemplary mass storage solutions may include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g., an array of disks (e.g., SATA arrays).

In an embodiment, the bus 920 communicatively couples the processor(s) 970 with the other memory, storage, and communication blocks. The bus 920 may be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects the processor 970 to the computer system 900.

In another embodiment, operator and administrative interfaces, e.g., a display, keyboard, and a cursor control device, may also be coupled to the bus 920 to support direct operator interaction with computer system 900. Other operator and administrative interfaces may be provided through network connections connected through communication port 960. In some embodiments, the external storage device 910 can be any kind of external hard-drives, floppy drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system 900 limit the scope of the present disclosure.

While the foregoing describes various embodiments of the present disclosure, other and further embodiments of the present disclosure may be devised without departing from the basic scope thereof. The scope of the present disclosure is determined by the claims that follow. The present disclosure is not limited to the described embodiments, versions or examples, which are included to enable a person having ordinary skill in the art to make and use the present disclosure when combined with information and knowledge available to the person having ordinary skill in the art.

Other embodiments of the present disclosure will be apparent to those skilled in the art from consideration of the specification and practice of the present disclosure. It is intended that the specification and examples be considered as exemplary only, with a true scope and spirit of the present disclosure being indicated by the following claims.

What is claimed is:

1. A method for processing multimodal inputs from users, comprising:
interacting, by a processor, with a user on a first multimodal interface using an artificial intelligence (AI) engine, wherein the interaction comprises:
receiving, by the processor, one or more inputs from the user through the first multimodal interface; and
transmitting, by the processor, one or more instructions generated by the AI engine based on the one or more inputs,
determining, by the processor, one or more assessment values based on the one or more inputs and the one or more instructions; and
displaying, by the processor, the one or more assessment values on a second multimodal interface.

2. The method of claim 1, wherein for displaying the one or more assessment values, the method comprises:
generating, by the processor, one or more media artifacts based on at least one of: the one or more inputs, the one or more instructions, or the one or more assessment values; and
displaying, by the processor, the one or more media artifacts on the second multimodal interface.

3. The method of claim 2, wherein for displaying the one or more media artifacts on the second multimodal interface, the method comprises:
identifying, by a compiler of the processor, a media type of the generated one or more media artifacts;
matching, by the processor, the media type of the generated one or more media artifacts with a media type of a corresponding tile of the second multimodal interface; and
routing, by the processor, the generated one or more media artifacts to the corresponding tile having a matching media type so that the generated one or more media artifacts display in the corresponding tile.

4. The method of claim 1, wherein the first multimodal interface comprises the second multimodal interface, and wherein the method comprises displaying, by the processor, the one or more assessment values in the first multimodal interface.

5. The method of claim 1, wherein the first multimodal interface comprises a tile having a chat interface, wherein the chat interface comprises a conversational AI agent coupled to the AI engine.

6. The method of claim 5, wherein the one or more inputs from the chat interface comprises capturing at least one of a video input or an audio input of the user, and wherein the method further comprises:
processing, by the conversational AI agent of the processor, the one or more inputs to analyze at least one of a sentiment, a tone, a facial expression, or a biometric data of the user; and
generating, by the AI engine of the processor, at least one of: audio, video, or textual artifacts based on feedback from the sentiment, the tone, the facial expression, or the biometric data analyzed.

7. The method of claim 5, further comprising:
retrieving, by the AI engine of the processor, information relevant to continue a conversation by the conversational AI agent with the user; and
displaying, by the processor, the retrieved information as one or more media artifacts on the first multimodal interface.

8. The method of claim 7, further comprising:
processing, by the conversational AI agent of the processor, the one or more media artifacts being viewed by the user; and
adapting, by the processor, the one or more media artifacts based on the processing during the conversation.

9. The method of claim 5, wherein the one or more instructions comprise instructions to interact with other tiles on the first multimodal interface.

10. The method of claim 5, wherein a personality of the conversational AI agent is selected by the user.

11. The method of claim 1, wherein the one or more assessment values are determined by the AI engine.

12. The method of claim 1, wherein the one or more assessment values are determined based on inputs received in response to the one or more instructions.

13. The method of claim 1, wherein the first multimodal interface comprises at least one tile corresponding to a two-way video conferencing streaming video service.

14. The method of claim 1, wherein the first multimodal interface and the second multimodal interface are displayed on different computing devices.

15. The method of claim 1, wherein the first multimodal interface comprises one or more tiles configured to display a corresponding media artifact, and wherein the method further comprises:
receiving the one or more inputs from the user through the one or more tiles, wherein the one or more tiles are configured to communicate with at least one of: other tiles or an external entity;
receiving, by the processor, one or more retrieved data from either the other tiles or the external entity, wherein the other tiles or the external entity are configured to retrieve and transmit the one or more retrieved data in response to the one or more inputs; and
updating, by the processor, the corresponding media artifact displayed on the one or more tiles based on at least one of the one or more inputs or the one or more retrieved data.

16. The method of claim 15, wherein communication between the one or more tiles comprises a first tile of the one or more tiles subscribing to events of a second tile of the one or more tiles.

17. The method of claim 16, wherein the method further comprises updating, by the processor, the first tile in response to a user interaction with the second tile.

18. The method of claim 1, further comprising:
querying, by the processor, one or more external entities based on the one or more inputs to retrieve a plurality of media artifacts; and
selecting, by the AI engine of the processor, a subset of the plurality of media artifacts to be displayed concurrently on the first multimodal interface, wherein the selected subset comprises at least two different media types providing complementary information.

19. A system for processing multimodal inputs from users, the system comprising:
a processor; and
a memory coupled to the processor, wherein the memory comprises one or more processor-executable instructions that, when executed by the processor, cause the processor to:
interact with a user on a first multimodal interface using an artificial intelligence (AI) engine, wherein the interaction comprises:
receiving one or more inputs from the user through the first multimodal interface; and
transmitting one or more instructions generated by the AI engine based on the one or more inputs;
determine one or more assessment values based on the one or more inputs and the one or more instructions; and
display the one or more assessment values on a second multimodal interface.

20. A non-transitory computer-readable medium comprising instructions that, when executed by a processor, cause the processor to perform operations comprising:
interacting with a user on a first multimodal interface using an artificial intelligence (AI) engine, wherein the interaction comprises:
receiving one or more inputs from the user through the first multimodal interface; and
transmitting one or more instructions generated by the AI engine based on the one or more inputs;
determining one or more assessment values based on the one or more inputs and the one or more instructions; and
displaying the one or more assessment values on a second multimodal interface.
